(19) United States
(12) Patent Application Publication
(10) Pub. No.: US 2023/0339181 A1
(43) Pub. Date: Oct. 26, 2023

(54) ULTRA ACTIVE MICRO-REACTOR BASED ADDITIVE MANUFACTURING

(71) Applicants: MOHSEN HABIBI, MONTREAL (CA); MUTHUKUMARAN PACKIRISAMY, PIERREFONDS (CA); SHERVIN FOROUGHI, MONTREAL (CA)

(72) Inventors: MOHSEN HABIBI, MONTREAL (CA); MUTHUKUMARAN PACKIRISAMY, PIERREFONDS (CA); SHERVIN FOROUGHI, MONTREAL (CA)

(21) Appl. No.: 18/005,839

(22) PCT Filed: Jul. 9, 2021
(86) PCT No.: PCT/CA2021/050941

§ 371 Date: Jan. 17, 2023

Related U.S. Application Data
(60) Provisional application No. 63/052,044, filed on Jul. 15, 2020.

(51) Int. Cl. B29C 64/264; B29C 64/118; B33Y 10/00

(52) U.S. Cl. CPC B29C 64/264; B29C 64/118; B33Y 10/00

(57) ABSTRACT

Current additive manufacturing (AM) technologies are limited to generating pixels which are significantly larger than the spot size of the energy source (ES) employed to generate the pixels. Accordingly, the minimum dimensions of parts, the complexity of the parts, their surface finish etc. are limited by the dimensions of these pixels. Accordingly, the invention provides manufacturers and designers with access to AM processes which results in pixels which can be:
generated individually with dimensions smaller than those currently achieved;
generated concurrently on a plane; or
generated concurrently in a volume.

Further, inventive AM processes described offer faster processing speeds than current prior art AM processes. Additionally, the inventive AM processes support manufacturing of specific materials/parts with a single monolithic part comprising multiple regions with different porosity, pore dimensions or connected/unconnected pore structure.

### CROSS-REFERENCE TO RELATED APPLICATIONS

This application claims the benefit of priority as a 371 National Phase Entry application of PCT/CA2021/050941 filed Jul. 9, 2021; which itself claims the benefit of priority from U.S. Provisional Patent Application 63/052,044 filed Jul. 15, 2020.

### FIELD OF THE INVENTION

This patent application relates to relates to additive manufacturing and more particularly to ultra active micro-reactors (UAMRs) exploiting dense energy transfer, holographic or metamaterial image generation for triggering UAMRs, nozzle based energy sources for UAMR based manufacturing, standing wave and focused wave printing systems for UAMR based manufacturing and UAMR based formation of porous structures.

### BACKGROUND OF THE INVENTION

In contrast to subtractive manufacturing methods such as machining, Additive Manufacturing (AM) is a class of manufacturing processes based on adding building materials layer-by-layer or pixel-by-pixel. The first AM invention appeared in 1986 since when many inventions have been developed however, the absolute dominant Energy Sources (ESs) used in AM processes are limited to laser, UV, and heat. The laser source is used for sintering powders in a method called powder bed laser sintering. UV laser is used to polymerize UV curing resin in a method called Stereolithography (SLA). The heater is used to melt the filament in a method called Fused Deposition Modeling (FDM). In addition, the heat is used to sinter the powders of the green part produced in binder jet printers. American Society for Testing and Materials (ASTM) categorized AM technologies into seven processes as:
1) Material Jetting (ES: heat);
2) Powder Bed Fusion (ES: laser);
3) Binder Jetting (ES: heat);
4) Direct Energy Deposition (ES: laser/heat);
5) Material Extrusion (ES: heat);
6) Sheet Lamination (ES: Heat/Ultrasound); and
7) Vat Photopolymerization (ES:UV).

Each of these AM technologies is limited to generating pixels which are significantly larger than the spot size of the ES employed to generate the pixels. Accordingly, the minimum dimensions of parts, the complexity of the parts, their surface finish etc. are limited by the dimensions of these pixels. Accordingly, it would be beneficial to provide manufacturers and designers with access to an AM process which results in pixels which are either generated individually with dimensions smaller than those currently achieved, generated concurrently on a plane, or generated concurrently in a volume. It would be further beneficial for manufacturers to exploit such AM processes which offer faster processing speeds than current prior art AM processes as well as supporting manufacturing of specific materials/parts such as, for example, a monolithic part comprising multiple regions with different porosity, pore dimensions or connected/unconnected pore structure.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to additive manufacturing and more particularly to ultra active micro-reactors (UAMRs) exploiting dense energy transfer, holographic or metamaterial image generation for triggering UAMRs, nozzle based energy sources for UAMR based manufacturing, standing wave and focused wave printing systems for UAMR based manufacturing and UAMR based formation of porous structures.

In accordance with an embodiment of the invention there is provided a method of manufacturing a structures, comprising:
providing a plurality of transmitting elements, each transmitting element of the plurality of transmitting elements generating a predetermined wave type directed into at least one of a build chamber and a medium chamber;
providing a build material within at least one of the build chamber and the medium chamber comprising at least one of a resin, a slurry and a powder comprising coated particles;
exciting a predetermined portion of the plurality of transmitting elements into predetermined states in order to generate a plurality of waves into the at least one of the build chamber and the medium chamber to generate a wave image; wherein
the wave image generates an energy density of the waves which trigger a plurality of micro-reactors within the build material thereby solidifying a portion of the build material within the wave image; and
the wave image relates to a predetermined portion of a part to be manufactured.

In accordance with an embodiment of the invention there is provided a system for manufacturing comprising:
a plurality of phase changing elements within a medium chamber between a plurality of energy sources and a build chamber within which manufacturing an additive manufacturing process is executed;
the plurality of energy sources, each energy source of the plurality of energy sources generating waves of a predetermined type;
the build chamber; and
the medium chamber; wherein
the medium chamber is filled with one or more materials providing transmission of the waves of the predetermined type from the plurality of energy sources to the build chamber via the plurality of phase changing elements.

In accordance with an embodiment of the invention there is provided a system for manufacturing a part comprising:
a nozzle comprising:
   a focused energy sources having a focal region; and
   a material injection channel for delivering one or more materials of a plurality of materials to the focal region.

In accordance with an embodiment of the invention there is provided a system comprising: a plurality of energy sources each generating waves of a predetermined type;
a build chamber for holding a build material during generation of a part; and
a medium chamber comprising a medium upon which or within which the one or more energy sources are disposed; wherein
the medium supports transmission of the waves generated by the plurality of energy sources; and
the waves from the plurality of energy sources generate a standing wave at a predetermined position within the build chamber in dependence upon configuration settings applied to each energy source of the plurality of energy sources.

In accordance with an embodiment of the invention there is provided a system for generating a porous material comprising:
a plurality of energy sources each generating waves of a predetermined type;
a build chamber for holding a build material during generation of a part; and
a medium chamber comprising a medium upon which or within which the one or more energy sources are disposed; wherein
the medium supports transmission of the waves generated by the plurality of energy sources;
the waves from the plurality of energy sources generate a standing wave at a predetermined position within the build chamber in dependence upon configuration settings applied to each energy source of the plurality of energy sources; and
the build material when processed by the plurality of energy sources comprises at least one region of a plurality of regions where each region of the plurality of regions is characterized by having pores of at least one of a predetermined range of dimensions, a predetermined pore density, an unconnected pore structure, and a connected pore structure.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an additive manufacturing “spot” according to the prior art versus an Ultra Active Micro-Reactor (UAMR) according to embodiments of the invention;

FIG. 2 depicts schematically ultrafast energy transfer via UAMRs according to embodiments of the invention to form the desired part;

FIGS. 3A to 3F depict exemplary configurations of a three-dimensional (3D) additive manufacturing (AM) printers according to embodiments of the invention;

FIGS. 4A and 4B depict schematically exploiting X-wave interference in conjunction with UAMRs according to embodiments of the invention to generate parts via a 3D AM process;

FIGS. 5A and 5B depict schematically exploiting X-wave interference in conjunction with UAMRs and a substrate according to embodiments of the invention to generate parts via a 3D AM process;

FIGS. 6A and 6B depict schematically a simplified 3D AM printer design according to the embodiment of the invention depicted in FIG. 3A;

FIG. 7 depicts an implement an acoustic 3D AM printer according to the design depicted in FIGS. 3A, 6A and 6B respectively;

FIG. 8 depicts a sample 3D printed part formed in polydimethylsiloxane (PDMS) using the exemplary 3D AM printer depicted in FIG. 7;

FIGS. 9A and 9B depict results obtained with an acoustic 3D AM printer according to FIG. 7 at a powers of 218 W and 150 W respectively;

FIG. 10 depicts an embodiment of a “holographic” 3D AM printer exploiting a hologram or meta-material between the energy source and the build material;

FIG. 11 depicts an embodiment of a “holographic” 3D AM printer exploiting a hologram or meta-material wherein the transduction medium from the energy source and the build material are separated by a build chamber;

FIG. 12 depicts an embodiment of a “holographic” 3D AM printer exploiting a hologram or meta-material between the energy source and the build material for fabricating a printed electrical circuit according to an embodiment of the invention;

FIG. 13 depicts an embodiment of a “holographic” 3D AM printer exploiting a hologram or meta-material wherein the transduction medium from the energy source and the build material are separated by a build chamber for fabricating a PCB according to an embodiment of the invention;

FIG. 14 depicts an embodiment of a “holographic” 3D AM printer exploiting a hologram or meta-material wherein the part is grown progressively in dependence upon movement of the hologram or meta-material according to an embodiment of the invention;

FIG. 15 depicts printing a multi-sectional object using a single hologram or meta-material within a “holographic” 3D AM printer according to an embodiment of the invention;

FIG. 16 depicts an exemplary flowchart for generating a part using an acoustic energy source with progressive printing in conjunction with a “holographic” 3D AM printer exploiting a hologram or meta-material according to an embodiment of the invention;

FIG. 17 depicts an exemplary process for progressively printing a part using a “holographic” 3D AM printer exploiting a hologram or meta-material according to an embodiment of the invention;

FIG. 18 depicts schematically an exemplary process of printing a part without a platform using a “holographic” 3D AM printer exploiting a hologram or meta-material according to an embodiment of the invention;

FIG. 19 depicts an active hologram according to an embodiment of the invention exploiting height configurable elements to provide the hologram or meta-material within a “holographic” 3D AM printer exploiting a hologram or meta-material according to an embodiment of the invention;

FIG. 20 depicts an active hologram according to an embodiment of the invention exploiting phase configurable elements to provide the hologram or meta-material within a “holographic” 3D AM printer exploiting a hologram or meta-material according to an embodiment of the invention;

FIG. 21 depicts schematically storing multiple complex images within a single hologram or metal-material to provide the hologram or meta-material within a “holographic” 3D AM printer exploiting a hologram or meta-material according to an embodiment of the invention;

FIGS. 22A and 22B depict the real and imaginary parts of the pressure at the surface of a hologram or meta-material to provide the hologram or meta-material within a “holographic” 3D AM printer exploiting a hologram or meta-material according to an embodiment of the invention;

FIG. 23 depicts the result of finite element modelling (FEM) of acoustic energy from a source coupled via the acoustic hologram having the real and imaginary pressure components as depicted in FIGS. 22A and 22B respectively showing that the target star pattern is created at the target plane 5 mm from the hologram or meta-material;

FIG. 24A depicts the hologram, acoustic pressure pattern and printed part using a “holographic” 3D AM printer according to an embodiment of the invention exploiting a hologram or meta-material according to an embodiment of the invention to print a spiral piece-part;

FIG. 24B depicts the hologram, acoustic pressure pattern and printed part using a “holographic” 3D AM printer according to an embodiment of the invention exploiting a hologram or meta-material according to an embodiment of the invention to print an impeller;

FIG. 24C depicts the hologram, acoustic pressure pattern and printed part using a “holographic” 3D AM printer according to an embodiment of the invention exploiting a hologram or meta-material according to an embodiment of the invention to print a gear;

FIGS. 25A and 25B depict schematically a compact mechanism generally and in detail view for forming a part using a 3D AM printer exploiting a nozzle based compact mechanism in conjunction with UAMRs according to an embodiment of the invention;

FIG. 26A depicts schematics of a single monolithic focused energy source, a phased array focused energy source and a hologram/meta-material focused energy source respectively supporting 3D AM printing according to embodiments of the invention;

FIG. 26B depicts a schematic of a focused energy source according to an embodiment of the invention for using within a 3D AM printer according to an embodiment of the invention;

FIG. 27 depicts the focused energy source as depicted in FIG. 26B deployed within a 3D AM printer according to an embodiment of the invention wherein the focused energy source is embedded within a polymer resin;

FIG. 28 depicts the methodology of printing 2D or 3D parts using the focused energy source and 3D AM printer according to embodiments of the invention as depicted in FIG. 27;

FIGS. 29A to 29C depict focused energy sources according to embodiments of the invention to provide different configurations of an operational front surface of the focused energy source;

FIGS. 30A and 30B depict cross-sectional and end views respectively of focused energy source print nozzle with a resin injection channel according to an embodiment of the invention;

FIG. 31A depicts a cross-sectional view of a focused energy source (FES) print nozzle with a central resin injection channel according to an embodiment of the invention;

FIG. 31B depicts a cross-sectional view of a FES print nozzle with a side channel supply and central resin injection channel according to an embodiment of the invention;

FIG. 32 depicts a cross-sectional view of a FES print nozzle with a central resin injection channel exploiting a ring type line focused (RLF) energy source according to an embodiment of the invention;

FIG. 33A depicts an exemplary schematic of a 3D AM printer according to an embodiment of the invention exploiting FES print nozzles;

FIG. 33B depicts an exemplary print head for a 3D AM printer such as depicted in FIG. 33A exploiting focused energy print nozzles according to an embodiment of the invention;

FIG. 34A depicts an exemplary print head for a 3D AM printer such as depicted in FIG. 33A exploiting focused energy print nozzles according to an embodiment of the invention;

FIG. 34B depicts an exemplary print head for a 3D AM printer such as depicted in FIG. 33A exploiting a combined focused energy print nozzle assembly according to an embodiment of the invention;

FIG. 35A depicts schematically the arrangement of a pair of adjacent FES print nozzles within the print head depicted in FIG. 34B;

FIG. 35B depicts an open housing design according to an embodiment of the invention for printing on a platform within a FES print nozzle or print head according to an embodiment of the invention;

FIG. 36 depicts an experimental prototype system exploiting a FES print nozzle according to an embodiment of the invention;

FIG. 37 depicts an optical micrograph of a prototype FES print nozzle according to an embodiment of the invention;

FIG. 38 depicts printed parts using the prototype FES print nozzle of FIG. 37;

FIG. 39 depicts the printed part volume versus time of printing using the prototype FES print nozzle of FIG. 37;

FIG. 40 depicts schematically the concept of static trapped UAMR printing according to an embodiment of the invention;

FIG. 41 depicts schematically the concept of dynamic trapped UAMR printing according to an embodiment of the invention;

FIG. 42 depicts schematically the concept of dynamic trapped UAMR printing according to an embodiment of the invention with monolithic energy sources;

FIGS. 43 and 44 depict perspective and cross-sectional views respectively of a 3D AM printer using a FES according to an embodiment of the invention;

FIG. 45 depicts a schematic of an exemplary FES according to an embodiment of the invention;

FIG. 46 depicts reflection and refraction of transmitted X-waves within a FES according to an embodiment of the invention;

FIG. 47 depicts pressure and shear X-wave transmission coefficients versus incident angle with a FES into polystyrene transmitted from water;

FIG. 48 depicts a schematic view of the Schematic view of transmitting length and the thickness of the cavity as energy from a FES is transmitted through several media;

FIG. 49 depicts a schematic of a printing tank for an exemplary FES based 3D AM printer according to an embodiment of the invention;

FIGS. 50 and 51 depict perspective views of the printing tank for exemplary FES based 3D AM printer according to an embodiment of the invention;

FIGS. 52 and 53 depict an optical micrograph and schematic respectively of a prototype FES based 3D AM printer according to an embodiment of the invention;

FIGS. 54A and 54B depict a schematic and optical micrograph respectively of the FES and printing tank for a prototype FES based 3D AM printer according to an embodiment of the invention;

FIG. 55 depicts a CAD model of a target 3D printed object;

FIG. 56 depicts an optical micrograph of a fabricated 3D printed object using the CAD model of FIG. 55 with the exemplary prototype FES based 3D AM printer according to an embodiment of the invention depicted in FIG. 52;

FIG. 57 depicts accessibility and focusing ability for a FES based 3D AM printer according to an embodiment of the invention;

FIG. 58 depicts exemplary schematics of exploiting a FES based 3D AM printer according to an embodiment of the invention in conjunction with a robotic arm or robotic system;

FIG. 59 depicts an exemplary schematic of exploiting multiple a FES based 3D AM printers according to an embodiment of the invention in conjunction with multiple robotic arms or robotic systems;

FIG. 60 depicts an optical micrograph of a robotically manipulated FES based 3D AM printer according to an embodiment of the invention;

FIG. 61 depicts an optical micrograph of a fabricated part using the robotic FES based 3D AM printer according to an embodiment of the invention depicted in FIG. 60;

FIGS. 62 to 64 depict perspective, cross-sectional and end elevation views respectively of robotic a FES based 3D AM printer according to an embodiment of the invention to form a hollow structure;

FIGS. 65A and 65B respectively depict schematics of a corrugated wall pipe and pipe with longitudinal holes which can be fabricated using the robotic FES based 3D AM printer according to an embodiment of the invention depicted in FIGS. 62 to 64 respectively;

FIG. 66 depicts schematically the generation of inactive micro-voids (IMVs) within a material exploiting UAMRs according to an embodiment of the invention to form a porous material;

FIG. 67 depicts three scenarios of forming IMVs within a 3D printed material exploiting UAMRs according to embodiments of the invention;

FIG. 68 depicts schematically a composite material employing nano-particles, macro-particles, and fibers according to an embodiment of the invention;

FIG. 69 depicts examples of FES sources as described and depicted within the specification for use within a FES based 3D AM printer according to an embodiment of the invention;

FIG. 70 depicts schematically forming a porous panel using IMVs and UAMRs in association with a FES based 3D AM printer according to an embodiment of the invention;

FIG. 71 depicts schematically a FES based foam spray nozzle methodology using IMVs and UAMRs in association with a FES based 3D AM printer according to an embodiment of the invention;

FIG. 72 depicts schematically forming a porous shim within a structure using IMVs and UAMRs in association with a FES based 3D AM printer according to an embodiment of the invention;

FIG. 73 depicts schematically forming a 3D part with varying porosity upon a platform using either a monolithic FES or holographic/meta-material based FES in conjunction with IMVs and UAMRs according to an embodiment of the invention;

FIG. 74 depicts schematically forming a 3D part with varying porosity without a platform through X-wave interference using either a monolithic FES or holographic/meta-material based FES in conjunction with IMVs and UAMRs according to an embodiment of the invention;

FIG. 75A depict a CAD model and optical micrographs of porous piece-parts fabricated with a 3D AM printer according to an embodiment of the invention; and

FIG. 75B depicts scanning electron micrograph (SEM) images of the fabricated piece-art of FIG. 75A showing varying porosity.

### DETAILED DESCRIPTION

The present invention is directed to additive manufacturing and more particularly to ultra active micro-reactors (UAMRs) exploiting dense energy transfer, holographic or metamaterial image generation for triggering UAMRs, nozzle based energy sources for UAMR based manufacturing, standing wave and focused wave printing systems for UAMR based manufacturing and UAMR based formation of porous structures.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers, or groups thereof and that the terms are not to be construed as specifying components, features, steps, or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed, or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List of file formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “CAD model” as used herein may refer to, but is not limited to, an electronic file containing information relating to a component, piece-part, element, assembly to be manufactured. A CAD model may define an object within a two-dimensional (2D) space or a three-dimensional (3D) space and may in addition to defining the internal and/or external geometry and structure of the object include information relating to the material(s), process(es), dimensions, tolerances, etc. Within embodiments of the invention the CAD model may be generated and transmitted as electronic content to a system providing manufacturing according to one or more embodiments of the invention. Within other embodiments of the invention the CAD model may be derived based upon one or more items of electronic content directly, e.g. a 3D model may be created from a series of 2D images, or extracted from electronic content.

A “fluid” as used herein may refer to, but is not limited to, a substance that continually deforms (flows) under an applied shear stress. Fluids may include, but are not limited to, liquids, gases, plasmas, and some plastic solids.

A “powder” as used herein may refer to, but is not limited to, a dry, bulk solid composed of a large number of exceptionally fine particles that may flow freely when shaken or tilted. Powders may be defined by both a combination of the material or materials they are formed from and the particle dimensions such as minimum, maximum, distribution etc. A powder may typically refer to those granular materials that have fine grain sizes but may also include larger grain sizes depending upon the dimensions of the part being manufactured, the characteristics of the additive manufacturing system etc.

A “metal” as used herein may refer to, but is not limited to, a material having good electrical and thermal conductivity. Metals are generally malleable, fusible, and ductile. Metals as used herein may refer to elements, such as gold, silver, copper, aluminum, iron, etc. as well as alloys such as bronze, stainless steel, steel etc.

A “resin” as used herein may refer to, but is not limited to, a solid or highly viscous substance which is typically convertible into polymers. Resins may be plant-derived or synthetic in origin.

An “insulator” as used herein may refer to, but is not limited to, a material whose internal electric charges do not flow freely, and therefore make it nearly impossible to conduct an electric current under the influence of an electric field.

A “ceramic” as used herein may refer to, but is not limited to, an inorganic, nonmetallic solid material comprising metal, non-metal or metalloid atoms primarily held in ionic and covalent bonds. Such ceramics may be crystalline materials such as oxide, nitride or carbide materials, elements such as carbon or silicon, and non-crystalline.

A “polymer” as used herein may refer to, but is not limited to, is a large molecule, or macromolecule, composed of many repeated subunits. Such polymers may be natural and synthetic and typically created via polymerization of multiple monomers. Polymers through their large molecular mass may provide unique physical properties, including toughness, viscoelasticity, and a tendency to form glasses and semi-crystalline structures rather than crystals.

A “robot” or “robotic system” as used herein may refer to, but is not limited to, mechanical systems providing control of movement of a portion or portion of portions of the mechanical system under user or computer control. A robot would have a frame, form or shape designed to achieve a particular task together with electrical components which power and control the robot and some contain some level of computer programming code. A robot may be fixed or mobile and may include a system designed to mimic a biological form, e.g. an android.

An “energy source” as used herein may refer to, but is not limited to, an element creating an emitted signal within an additive manufacturing (AM) system according to or exploiting one or more embodiments of the invention. A energy source may refer solely to that portion of each element generating the emitted signal, e.g. a transducer, or it may refer to the element generating the emitted signal together with part or all of the associated control and drive circuitry receiving control data, processing the control data, and generating the appropriate drive signal(s) to the element generating the emitted signal. A energy source may generate an emitted signal selected from the group comprising infrared (IR) radiation, visible radiation, ultraviolet (UV) radiation, microwave radiation, radio frequency (RF) radiation, X-ray radiation, electron beam radiation, an ultrasonic signal, an acoustic signal, a hypersonic signal, a magnetic field and an electric field. Whilst an energy source may refer to a single emitted signal type other energy sources may emit multiple signals. The physical dimensions of an energy source may vary according to the dimensions of the AM system they form part as well as the number of discretized emitters within the AM system. Accordingly, energy sources may be pico-elements having dimensions defined in picometers (10⁻¹² m) or Angstroms (10⁻¹⁰ m), nano-elements having dimensions defined in nanometers (10⁻⁹ m), micro-elements having dimensions defined in micrometers (10⁻⁶ m), as well as elements having dimensions defined in millimeters (10⁻¹² m), centimeters (10⁻² m), meters (10⁰ m) and decameters (10¹ m).

An “X-wave” as used herein may refer to, but is not limited to, a wave or field generated by an energy source which propagates from the energy source through one or more media. An X-wave may accordingly be an emitted wave or field selected from the group comprising near-infrared (IR) radiation, far (IR) radiation, visible radiation, ultraviolet (UV) radiation, microwave radiation, radio frequency (RF) radiation, X-ray radiation, electron beam radiation, an ultrasonic signal, an acoustic signal, a hypersonic signal, a magnetic field and an electric field.

A “nanoparticle” or “ultrafine particle” as used herein may refer to, but is not limited to, a particle of matter that is between 1 and 100 nanometers (nm) in diameter. However, the term may also be employed for larger particles, for example up to 500 nm, or nanofibers (solid fibers with length substantially larger than cross-sectional dimensions) and nanotubes tubes (hollow cored particles with lengths substantially larger than cross-sectional dimensions) that are less than 100 nm in only two directions.

1. Dense Energy Transfer Exploiting Ultra Active Micro-Reactors (UCON-236)

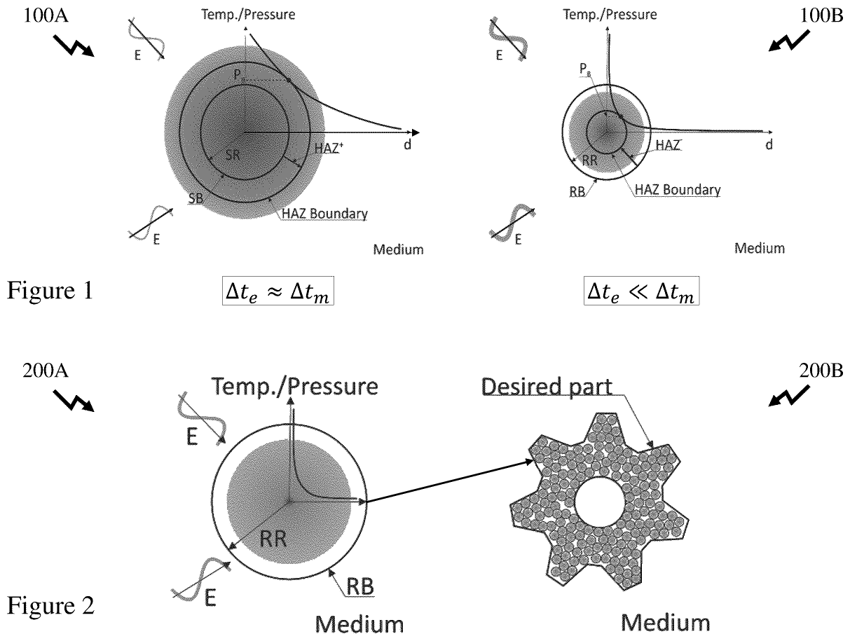

Heat and pressure are generally used as the main sources of driving phase changes in materials, between gas, liquid, and solid phases. A material phase change from liquid to solid is one of the most desired phase transfer for manufacturing purposes. This phase transfer can be in the form of polymerization/solidification of a liquid to the solid state using heat and/or pressure. This kind of heat transfer is created in the medium by a spot often created using heat generation devices, e.g. heating elements or laser sources, etc., as shown schematically in FIG. 1A, with the energy excitation time (Δte) is on the scale of milliseconds to microseconds depending on the energy source type. Further, the time of heat transfer (Δtm) between the center of the spot and the bulk surrounding medium is on the scale of milliseconds up to microseconds. These are relatively long times of approximately equal order for Δte and Δtm (Δte≈Δtm) facilitate the heat transfer and result in solidifying the surrounding medium rather than the desired geometry. The relatively slow source excitation, on the order of the heat transfer rate to local medium (Δte≈Δtm), further allows for heat transfer to the bulk medium surrounding the spot resulting in polymerization regions outside of the spot. The inventors refer to this as the positive heat affected zone (HAZ+). This inherent limitation of the HAZ+ in conventional additive manufacturing (AM) processes results from Δte≈Δtm which makes the minimum feature size larger than the source spot size. This therefore restricts the feature size as the phase transformation can happen over a long period of time spreading to the surrounding medium. This tends to lead to larger feature sizes and distortion of the desired geometry. Due to the spread of the HAZ beyond the spot size the HAZ is larger than the spot, hence positive HAZ (HAZ+). Conventional AM processes are inherently limited to operate under this spot generation and thereby with HAZ+. Typically, the enlarged feature size is larger than the spot diameter (2×SR where SR is spot radius shown in FIG. 1A). Accordingly, it is not possible to obtain minimum feature sizes of the fabricated parts smaller than 2×SR.

In contrast to conventional AM processes, the inventors have established an alternate manufacturing methodology to implement phase transfer in a smaller volume with a shorter excitation time (Δte<<Δtm) when compared to the nature of heat transfer time to the medium. Further, by generate high temperature and/or pressure with fast heating and cooling rates the result from the reaction sites according to embodiments of the invention is as depicted FIG. 1B. When the excitation time is on the order of nanoseconds (Δte<<Δtm) compared to milliseconds to microseconds for the transfer rate to the medium, all the excitation energy is concentrated to the center leading to sudden and rapid rise of temperature and/or pressure near the center of the excitation source with a rapid drop in temperature and/or pressure away from the center as shown in FIG. 1B. As a result, the bulk medium will not undergo phase transformation near the boundary. The phase transformation will happen only near the center where the temperature and pressure rise, i.e. within a distance on the scale of nanometers, with respect to the center.

Due to these extreme conditions, the inventors refer to these reaction sites as reactors or more specifically Ultra Active Micro-Reactors (UAMRs). The unaffected/not-phased transferred region between center and the boundary as shown in FIG. 1B is accordingly a negative heat affected zone (HAZ−). Accordingly, being able to create a UAMR or cluster of UAMRs, the heat transfer to the surrounding is negligible due to adiabatic energy/phase transfer inside the UAMR leading to no distortion or enlargement of feature size. As a result, the minimum feature size is decided by the size of UAMR (RR in FIG. 1B) itself which is not the case in the conventional AM for the spot generation. As the Heat Affected Zone (HAZ) for a UAMR is very smaller than the reactor size (RR) this results in the negative HAZ (HAZ−).

Within FIGS. 1A and 1B the labels correspond as follows, Spot Radius (SR), Reactor Radius (RR), Spot Boundary (SB), Reactor Boundary (RB), Heat Affected Zone (HAZ), Energy X-wave (E) and temperature/pressure threshold (PB).

Now referring to FIG. 2 there is depicted the concept of a UAMR under ultra-fast and ultra-dense energy excitation for the purpose of the phase transition according to embodiments of the invention. The temperature/pressure distribution across the UAMR is depicted in first image 200A. The exciting energy X-waves, E, may be acoustic, optical, X-ray etc. or a combination thereof. Accordingly, as depicted in first image 200A these created UAMRs with a Reactor Radius (RR) and with boundary, the vibrating boundary of excited atoms or molecules, the Reactor Boundary (RB). At the center of the reactor, high temperature and pressure are created in a very small region (of the order of nanometers wide) in a very short period of excitation time, Δte (nanoseconds or picoseconds typically). When the medium is the material to be solidified then the reactor works as a micro-factory for converting the liquid to the solid. Accordingly, by creating clusters of these reactors (UAMRs) over a selective volumetric range, a desired geometry such as that depicted in second image 200B can be generated through almost instant phase transition in the volumetric regions of the UAMRs. Accordingly, depending upon the design of the energy source the UAMRs can be excited to create structures in sequence or simultaneously.

Within embodiments of the invention the UAMRs exploit high frequency energy X-waves (e.g. X-rays) as the energy source to induce the micro-reactors (UAMRs) to solidify the building material locally within the build chamber. Accelerated chemical reactions within the UAMR is one routes rapid heat/pressure generation triggered from the excitation via X-rays for example. Chemical reactions need energy to proceed and the energy source determines the course of the chemical reactions. Traditional energy sources used in AM processes, such as heat, light, and ionizing radiation, act differently and create less pressure and energy per molecule in comparison to that generated by UAMRs. In addition, the duration of the immense high pressure and energy per molecules in a UAMR is very short in comparison with conventional energy sources in prior AM techniques. High intensity X-ray irradiation, therefore, for example, creates UAMRs in the build material thereby rapidly generating significant temperature and pressure increases locally in addition to offering extremely fast heating and cooling rates. Accordingly, these high energy excited chemical reaction based UAMRs present a novel methodology of implementing an AM process.

UAMRs can grow, oscillate, and undergo rapid collapse in liquids. UAMRs can be established within essentially any liquid once subjected to sufficiently high intensity excitation. A UAMR creates extreme local heat and causes the conditions for chemical reactions to occur. The temperature inside a reactor induced with high frequency X-waves in a room temperature medium can exceed 15000 K and the pressure can exceed 1000 bar with heating and cooling rates at approximately 1000 K/s. Due to this extreme heating and cooling rate the medium remains at the room temperature around the UAMR. These high-energy conditions can also cause bond cleavage and formation inside and close to UAMR's shell (i.e. at the Reaction Boundary (RB).

However, X-rays are not the only excitation source available for triggering UAMRs where other energy sources can be employed according to the specific reactions/materials etc. of the UAMRs. For example, phased array transducers with acoustic holograms and/or metamaterials can create acoustic pressure patterns and focal regions for the purposes of AM. However, to date they have been employed in conventional macro scale heating arising from the absorption of the acoustic energy by the medium rather than exploiting the acoustic signal/energy to trigger chemical and/or other rapid non-thermal processes. The same is true within the prior art of exploiting ultraviolet (UV) light to solidify the printing material. For example, within the prior art a passive acoustic hologram has been used to create predetermined acoustic pressure pattern for particle trapping. The particles were coated with a UV or heat sensitive materials (e.g. a resin). Once the particles were located (trapped) in the acoustic field, they are exposed to the UV or heat to fix their relative locations in the medium. In other words, particles were manipulated by the acoustic field and then their locations were fixed by heat or UV sources. Creating precise parts with this approach has been limited to date within the prior art. Acoustic energy has also been used in the prior art to sinter and melt the material within the acoustic field where the heat is generated and the temperature increased locally due to the material's absorption of acoustic signals, i.e. it has a high attenuation coefficient for signals at acoustic frequencies. However, controlling heat and temperature fields through such means have to date limited the applicability of these methods.

In contrast, the inventors proposed the use of high energy discrete or phase array sources such as X-rays and/or UV lasers in combination with intermediate “optics” such as holograms, metamaterials etc. to create UAMRs in the build material. The interference of multiple sources results in a pattern of high intensity regions wherein it is within these regions that the UAMRs create hot spots for accelerated solidification of the printing material.

As will become evident these UAMR based methodologies allow for AM fabricated parts with complex geometries and high accuracies as well as fast printing speeds.

1A: Exemplary System Architectures

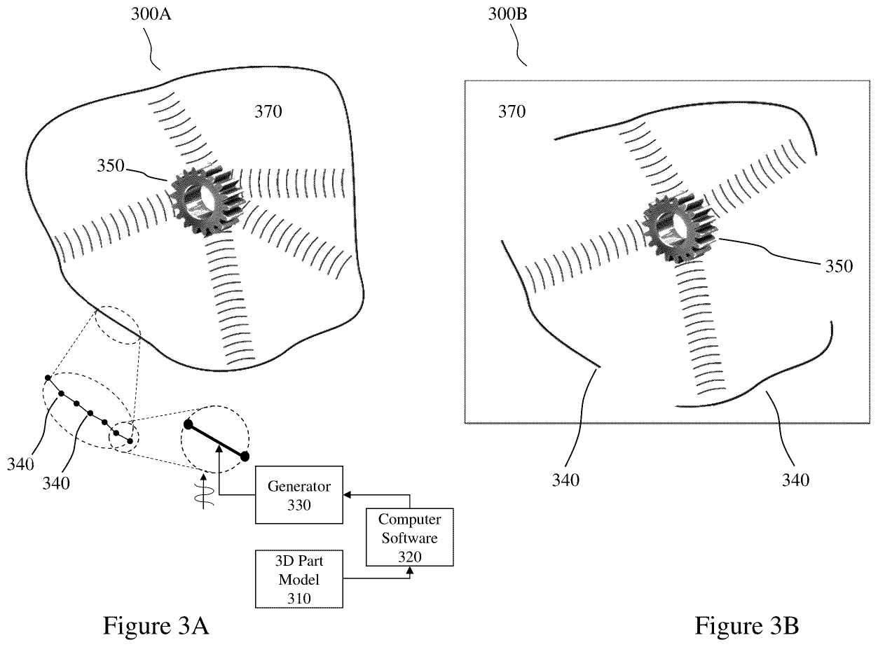

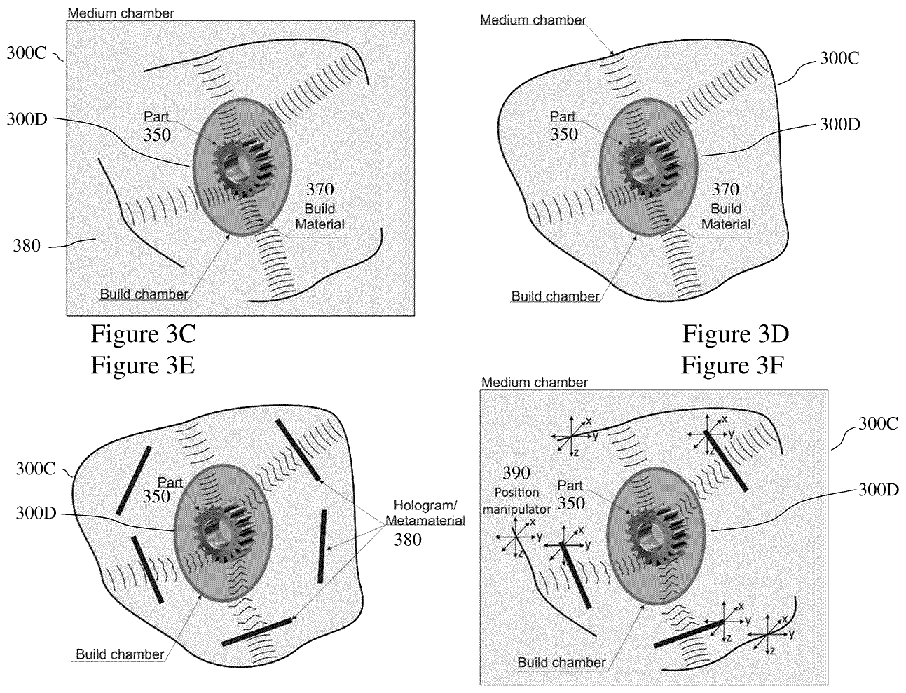

Referring to FIGS. 3A to 3F respectively there are depicted simplified schematic views of embodiments of the invention in six configurations. Referring to FIG. 3A there is depicted a Build Chamber 300A within which a Build Material 370 is disposed. The Build Chamber 300A comprises a plurality of Transmitting Elements 340 which generate the X-waves coupled into the Build Material 370 therein combining at the predetermined spatial points within the Build Chamber 300A to trigger the UAMRs thereby generating the Part 350. The Transmitting Elements 340 are coupled to Generators 330 which provide the appropriate power, control and, appropriate, initial energy X-wave(s). These Generators 330 are controlled by Computer Software 320 in execution upon one or more processors in dependence upon the 3D Part Model 310 stored in a memory accessible to the Computer Software 320. Alternatively, the Transmitting Elements 340 may be immersed, submerged, or deployed within the Build Chamber/Medium Chamber 300B as depicted in FIG. 3B or the between the Medium Chamber 300C and Build Chamber 300D as depicted in FIGS. 3C and 3D, respectively. Within embodiments of the invention the geometry of the Part 350 may define the pattern of transmission inside the build chambers in such a way that the three-dimensional image or near net shape image of the Part is projected in a region in the build chamber 350 such that the Part 350 is generated as a three-dimensional (3D) object without the layer-layer approach of the prior art. The interference of the X-waves within the build chambers triggering UAMR regions in the desired regions within the build chamber thereby triggering UAMRs within these UAMR regions. Outside these UAMR regions the X-wave pattern from the Transmitting Elements 340 being insufficient to trigger UAMRs within the Build Material 370.

Accordingly, within the generated UAMR regions the UAMRs cause extreme localized pressure and temperature over nanometer scales. The extraordinary fast heating and cooling rate at the hot spots keeps the temperature of the building material almost constant. The extreme localized high temperature, pressure and heating and cooling rates creates enormous kinetic energy to solidify the building material in the build chamber. Solidification, within some embodiments of the invention, refers to polymerization of a resin, a coating of a powder or powders or of the fluid of a slurry.

Referring to FIGS. 3E and 3F respectively embodiments of the invention are depicted wherein active or passive holograms/metamaterials 380 are located inside the Medium Chamber 300C externally to the Build Chamber 300D in order to guide, focus and/or pattern the transmitted X-waves from the Transmitting Elements 340 (not shown for clarity). Accordingly, in these embodiments of the invention the transmitting elements are discrete from the holograms/metamaterials themselves. Within FIGS. 3A and 3B respectively the Transmitting Elements 340 are in build material within the Build Chambers 300A and 300B, respectively. However, in FIGS. 3C to 3F respectively, the X-waves are transmitted from the transmitting elements via a medium and then pass through the build chamber. Refraction of the X-waves occurs where the transmitting medium changes. As depicted, this refraction happens at the two interfaces between the medium external to the Build Chamber 300D and the external surface of the shell of the Build Chamber 300D and between then between the inner surface of the shell of the Build Chamber 300D and the build material. These refractions are taken into consideration when calculating the X-wave transmitting patterns. FIG. 3F depicts an embodiment of the patent when the transmitting elements as well as holograms/metamaterials could have positional motions inside the medium. This scenario is used in the case study presented below but it would be evident to one of skill in the art that the other configurations can be employed without departing from the scope of the present patent as defined by the claims.

1B: Exemplary Embodiment

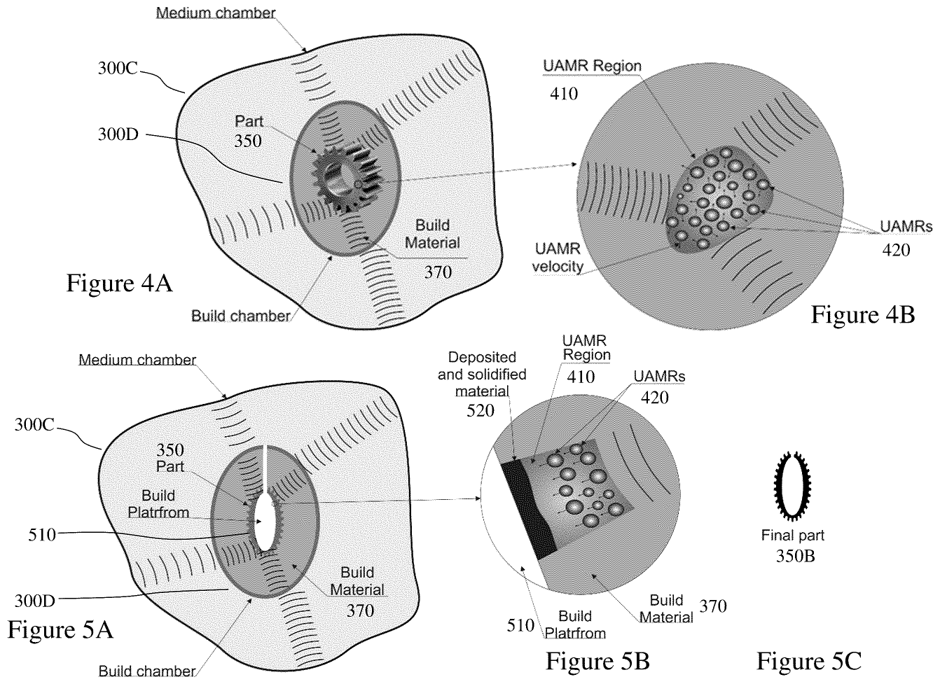

A detailed view of a region in the build chamber is shown in FIG. 4 comprising a Medium Chamber 300C within which is Build Chamber 300D within which the Part 350 will be formed. The Build Chamber 300D being filled with the Build Material 370 whilst the Medium Chamber 300C external to the Build chamber 300D is filled with Medium Material 380. The interference of X-waves from the Transmitting Elements 340 (no depicted for clarity) creates microscopic UAMR regions 410 within which the UAMRs 420 are formed as depicted in FIG. 4B. Each UAMR 429 contains the active reactors as hot spots for creating accelerated chemical reaction inside and in the vicinity of the hot spots. Due to non-linearity of the X-wave transmission, the X-waves could induce motion to the UAMRs. Accordingly, these induced forces can be balanced such as depicted in FIG. 4B with multiple X-waves impinging a UAMR region 410 and/or by using a Build Platform 510 such as depicted in FIGS. 5A and 5B to trap the UAMRs 420 and control the location of them in the Build Chamber 300D. The UAMR region 410 can be a small volume of the part or the whole volume of the part can be considered as one UAMR. For either case, the interference pattern of the X-waves can be calculated and established from the transmitting elements disposed around and/or within the Medium Chamber 300C. Importantly, the extraordinary kinetic energy arising from the very high pressure and temperature in the hot spots in addition to fast heating and cooling rate, creates a very fast polymerization reaction in comparison with streaming motion of the UAMR 420. Therefore, the UAMRs 420 can be solidified extraordinary faster than the movements of the UAMR 420 within the impinging X-waves. When the UAMRs 420 are solidified, since they are coagulated and attached to the neighboring UAMRs 420, the motion induced by the transmitted X-waves from the transmitting elements causes negligible effect on the UAMR 420 location of the created structure, Part 450.

Referring to FIGS. 5A and 5B another embodiment of the invention is depicted wherein the AM process occurs upon a platform (Build Platform 510) disposed within the Build Chamber 300D. The surface of the Build Platform 510 acts as a support for solidified and polymerized material to be deposited on pixel-by-pixel or layer-by-layer basis. Accordingly, the Build Platform 510 acts as a physical boundary or an auxiliary structure to trap UAMRs 420 within a UAMR region 410 where motion of the UAMRs 420 is induced from the transmitted X-waves from the transmitting elements as well these transmitted X-waves inducing the reactions within the UAMRs 420. Accordingly, the Build Platform 510 defines the geometry of the Final Part 350B.

1C: System and Material Factors

1C1: System Factors

Embodiments of the invention have multiple parameters effecting the pressure, temperature, and the heating and cooling duration in UAMR that can affect the AM process. Through controlling these parameters (online or offline), the printing accuracy, printed structure (e.g. porosity) and printing resolution can be adjusted. For example, the X-wave frequency from the transmitting elements effects the UAMR size and their size effects material parameters such as dimensions of pores and degree of porosity as well as the temperature and pressure inside the UAMRs. The X-wave intensity as well as spatial beam dimensions etc. from the transmitting elements defines the size of the UAMR region(s) and/or UAMR(s). X-wave intensity is a combination of power and the frequency of the transmitting elements as well as the number of beams combined, their spatial overlap etc. Therefore, many of the parameters are interconnected and hence effect on each other. Bulk temperature of the build material in the build chamber effects the UAMR content and collapse intensity. In the current prototype systems exploiting embodiments of the invention, due to highly attenuating build material and small size of the build chamber, the generated heat can be accumulated to increase the bulk temperature of the whole build chamber or at the macroscopic scale locally at UAMR. However, this may not be the case in all manufacturing systems exploiting embodiments of the invention. It should be noted that enormous kinetic energy of the drastically high pressure and temperature in the active UAMR do not affect the build temperature since the heating and cooling rate is extremely high. Therefore, in order to avoid bulk temperature variation in the build material in the current prototype systems exploiting embodiments of the invention or production AM systems according to embodiments of the invention a cooling system is (may be) implemented around the build chamber to transfer the generated heat due to attenuation of the build material. Static pressure in the medium affects the collapse intensity and UAMR content. UAMR content defines what is the resultant material of the printed object. Ambient gas also effects the UAMR intensity. And most importantly, choice of the build material has the prime effect on the resultant solidified material in UAMRs.

1C2: Printing Structure—Porosity Control

This will be addressed in more detail in Section 5 but in the scenarios where the induced UAMR collapses, it creates a set of voids. If the solidification process were faster than filling the void by the surrounding material, then these UAMRs would be trapped inside the solidified region and create a porous structure. The UAMR size and consequently, the porosity size, is controlled by adjusting the X-wave characteristics such as power and frequency. The characteristics of the build material such as density, viscosity, attenuation at the X-wave frequency and impedance, also effect the porosity. When considering resins, these generally comprise multiple parts that should be mixed and then the mixture starts the polymerization process. The mixing ratios of each part also affects the size of the porosity too. In case of transparent resins, the porous structure deteriorates the transparency of the part. Less porous means better transparency. In the embodiments of the invention, by controlling the characteristics of the build material and exciting X-wave (e.g. X-rays), the printed part can have a controllable range of the porosity and transparency. In addition, different porosity sizes in different regions of the part can also be achieved by controlling the X-waves in those regions.

1C3: Material

One of major capabilities of embodiments of the invention is the ability to induce free radical polymerization, hydrosilylation or ionic mechanism reactions which require the opening of bonds, such as the double-bond in vinyl terminated monomers, or any phase transitions using high intensity heat and temperature needed for UMAR for the purpose of manufacturing. In some embodiments of the invention, the UAMRs are created in order to generate free radicals and thereby trigger polymerization. In these embodiments of the invention, for example, monomers are radicalized on the border of UAMR wherein these radicals react during initiation, entry, propagation, and termination reactions and accordingly the monomers are polymerized.

Within embodiments of the invention, the build material may be, for example, a pure resin, a mixture of resins (different resin parts), solid powders (e.g. plastic, ceramic, glass, or metal powders) coated with resin, and/or a slurry of solid powders within a resin background. Essentially, any monomer that can be polymerized by the free radical polymerization process can be used as the structural substance. Examples of such monomers include, but are not limited to, dimethylsiloxane (DMS), methylmethacrylate (MMA), butylmethacrylate (BA), and vinylacrylate. Alternatively, monomers with a terminal vinyl or ethenyl functional group (—CH=CH₂) can be used. Nanoparticle synthesis of metal solutions such as gold (Au), silver (Ag), platinum (Pt), iron (Fe), nickel (Ni), palladium (Pd) for example as well as other organometallics can be applied to print multifunctional and composite parts. For example, adding carbon nanotubes (CNTs), metal nanoparticles and/or metal liquids to the polymer could make the printed object conductive and add physical and electrical multifunctionalities. Within other embodiments of the invention non-conductive nanoparticles may be added in order to provide specific functionality e.g. photon absorption (e.g. quantum dots), photon emission (e.g. quantum dots), mechanical integrity (e.g. carbon nanofibers), chemical reactions (e.g. catalysis with transition metal nanoparticles for example) etc.

1D: Case Study

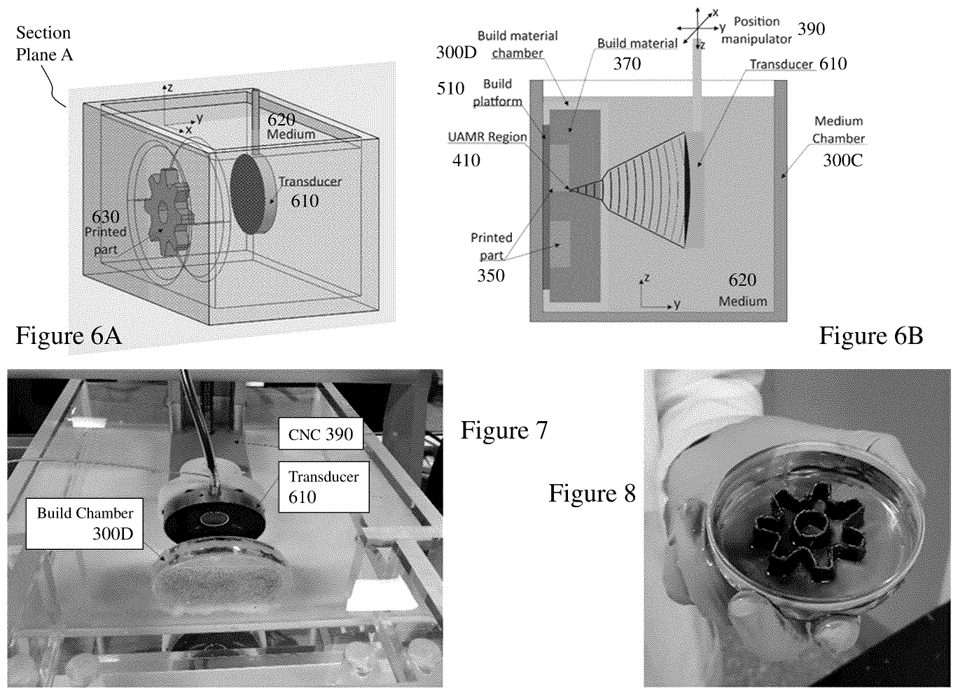

Referring to FIGS. 6A and 6B there are depicted schematically a simplified 3D AM printer design according to the embodiment of the invention depicted in FIG. 3A. The transmitting elements for the X-waves, in FIG. 3E, are replaced by a single spherical focused ultrasonic Transducer 610 connected to a position Manipulator 390. Accordingly, the ultrasound X-wave is transmitted from the Transducer 610 and passes though the medium 620, the shell of the build chamber 300D and the building material 370 respectively to reach the desired target point within the build chamber 300D. The movement and patterning of the field was achieved by the moving the Transducer 610 with a positional Manipulator 390 such as, for example, a Computer Numerical Controlled (CNC) machine or a robotic arm. FIG. 6A shows the three dimensional apparatus and FIG. 6B depicts the cross section view of Section Plane A. As shown in FIG. 6B, the printed part 350 is printed in the build chamber 300D on the build platform 510. The UAMR region 410 at the focal region of the transmitted ultrasonic X-wave. The UAMR region 410 is solidified and attached to the already printed part. The solidification of UAMR 410 is almost instant. The inventors have demonstrated that the Transducer 610 can be moved with the positional Manipulator 390 at speeds up to 300 mm/min with the Transducer 610 operating at applied electrical powers of 220 W although it is expected higher printing speeds can be achieved with increased power from the discrete Transducer 610 or through combining multiple transducers 610 at the focal region.

FIG. 7 depicts an implement an acoustic 3D AM printer according to the design depicted in FIGS. 3A, 6A and 6B respectively showing the Build Chamber 300D, Transducer 610, and Manipulator 390. FIG. 8 depicts a sample 3D printed part formed in polydimethylsiloxane (PDMS) using the exemplary 3D AM printer depicted in FIG. 7.

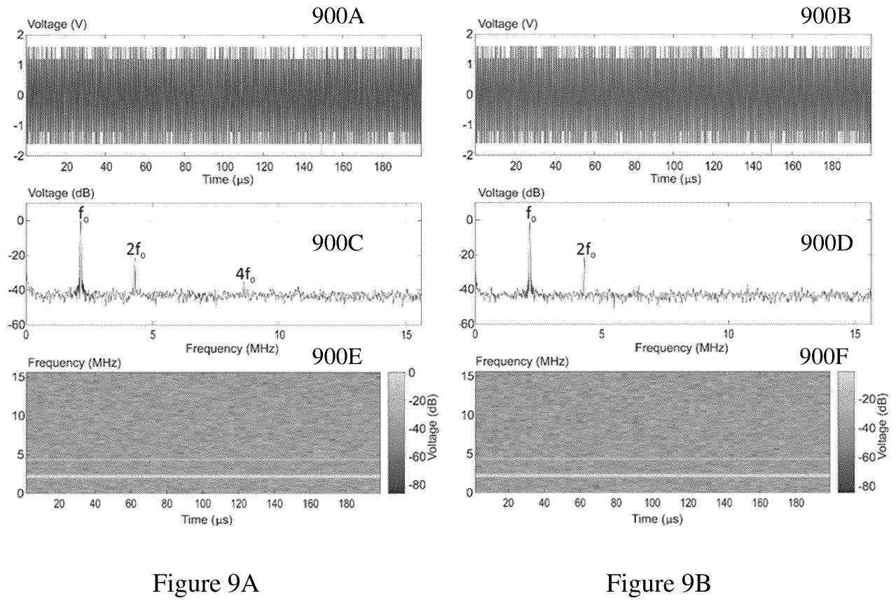

Referring to FIGS. 9A and 9B there are depicted experiments results obtained with an acoustic 3D AM printer according to FIG. 7 at applied electrical powers to the acoustic transducer of 218 W and 150 W respectively, where the driving frequency, f₀, was 2.15 MHz. The emitted energy from the focal region shows that only harmonics (n·f₀; n=1, 2, . . . ) appeared in the spectral analysis. This being an indicator of stable printing in the focal region where UAMRs are creating the part on the platform. First and second graphs 900A and 900B depict the driving signal to the transducer, third and fourth graphs 900C and 900D depicted the spectral analysis whilst fifth and sixth graphs 900E and 900F depict the temporal characteristics of the spectral analysis.

2. Holographic—Metamaterial Based Additive Manufacturing (UCON-246)

As noted above AM processes are generally based on pixel-by-pixel and layer-by-layer solidification of the build material to create three-dimensional objects. However, volumetric printing has also been recently introduced to create a three-dimensional image of the desired object in a container filled with printing material. However, to date these processes for the main source of energy employ light (e.g. laser) or heat. Photonic energy has to date been used for photopolymerization of liquid resin in stereolithography (SLA) or the sintering of powders in powder bed technology whilst heating elements are used in Fused Deposition Modeling (FDM) for melting and depositing printing materials. In contrast, the inventors have established locations of the desired image, regions filled with clusters of UAMRs, which can be induced in liquids. These UAMRs can grow, oscillate, and experience fast collapse in the printing material (e.g. a liquid resin). However, UAMRs can be created in any liquid material depending on the appropriate intensity and frequency of the exciting X-waves. Within the regions of these UAMRs extreme local temperature is produced which causes solidification of the printing material. Temperatures above 15000 K and the pressure higher than 1000 bar can be created at the center of the UAMRs on ultra-short timescales together with heating and cooling rates in excess of 1000 K/s. Accordingly, the temperature of the surrounding medium is kept almost constant and a very fast phase transition from liquid to solid occurs. Building upon the work presented above in respect of Section 1 the inventors have established within embodiments of the invention the use of holograms and/or metamaterials to pattern the non-conventional energy X-waves, such as sound or ultrasound, in order to create the desired images of the part in the build chamber filled with build material.

Within the prior art high frequency energy sources have been employed to selectively trap particles physically in specified patterns to build desired geometries through selective accumulation. Phased array transducers, acoustic holograms, and metamaterials are the transmitting elements used to create acoustic pressure patterns and focal regions for the purpose of physical particle manipulation and trapping. However, a second energy source such as a heater or photons (e.g. UV light) is employed to fix/glue/the particles, polymeric within the prior art, with respect to each other and therefore establish the desired geometry which is accordingly filled with polymeric particles. Within this prior art a passive acoustic hologram has been used to create pressure patterns for particle manipulation/trapping where the particles were coated with UV or heat sensitive resins. UV or heat would therefore fix/cure the coating of powders when the particles are trapped in the desired geometry. Alternatively, within another demonstration a metamaterial was used to create a temperature field pattern to melt and sinter directly to a substrate. However, it is difficult to generate the required heat through acoustic X-waves when seeking to employ metals. For example, due to the high melting temperature of metallic powders, the generated temperature should be in order of a few hundreds of degrees to start the sintering process. Further, the generated heat can easily transfer to other undesired regions by conduction and affect them as discussed above resulting in what the inventors refer to as a HAZ+ AM process in that the final particle size is larger than the zone within which the effect is initiated such that the produced objects have poor dimensional accuracy but also high surface roughness and an inhomogeneous structure. These limitations originating through the simple trapping, stacking mechanism and heating used in the process. In these processes, the heat transfer is very slow resulting the heat spreading to larger areas and hence larger spot sizes and shapes which are the limitations of these processes.

However, the inventors have established alternative method of using high frequency X-waves to create fast material phase transitions (e.g. liquid to solid) directly within the build material (e.g. liquid resin or coated powders) resulting in more controllable AM manufacturing to create homogenous and accurate parts. Accordingly, embodiments of the invention by generating highly focused temperature rises with nanosecond heating and cooling time results in highly accurate parts due to elimination of conduction heat transfer into the build material as in the conventional heat/UV curing AM process. Further, the part's structure can be adjusted by choosing the characteristic of the X-waves and consequently the UAMRs which generate these fast AM processes. Accordingly, methods according to embodiments of the invention provide a high level of flexibility for the creation of a wide range of micro-structures with the desired geometry. Accordingly, exploiting UAMRs allows for controlling the generated local heat and temperature fields limits within the build material such that methods according to embodiments of the invention provide for accurate parts.

Whilst a range of energy sources can be employed for generating the X-waves according to the materials being processed etc. the following description with respect to an exemplary embodiment of the invention exploits acoustic/ultrasonic signals as the X-waves in conjunction with resin coated powders such that the UAMRs are induced in the build material by these acoustic/ultrasonic X-waves. Accordingly, extraordinary high temperature on the scale of a few thousand degrees can be created inside the induced UAMR regions through the UAMRs within the desired locations in the build chamber with nanosecond time constant heating and cooling times. Due to these high heating and cooling rates, the generated heat does not transfer to other regions rather than desired locations. Therefore, the methods according to embodiments of the invention result in an accurate “green” part which can then be sintered via a subsequent process with a heat source either within the AM system or as part of a second processing stage. Accordingly, within embodiments of the invention the inventors utilize a combination of X-wave(s) (e.g. mechanical or electromagnetic X-waves) which are transmitted from holograms, phased array transducers and metamaterials to create clusters of UAMRs for fast solidification in the desired object volume in the build chamber. In other words, the embodiments of the invention use phase changing X-waves to induce direct material phase transformation(s).

2A: General Description of the Invention

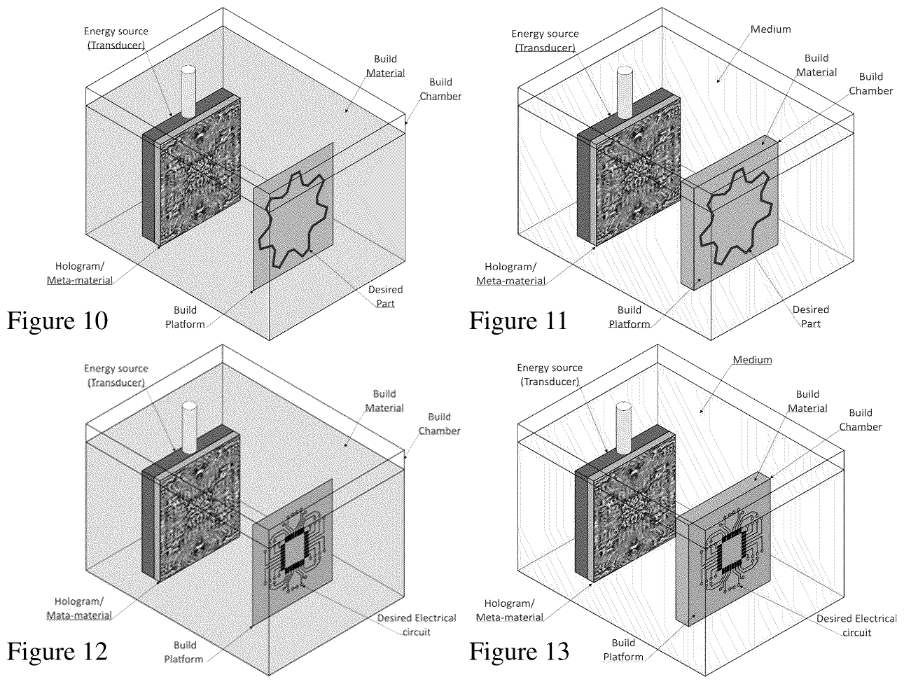

FIG. 10 depicts an embodiment of a “holographic” 3D AM printer according to an embodiment of the invention exploiting a hologram or meta-material between the energy source and the build material. A hologram or meta-material surface is attached to an energy source or disposed between the energy source and the build material. The X-waves are transmitted into the build material via the hologram surface. In this general embodiment of the invention, the build material also works as the energy transmitter medium for the X-waves to reach the build platform. The AM process occurring on the build platform by appropriate positioning of the build platform relative to the energy source/hologram or energy source/hologram relative to the build platform. The hologram is designed such that a high acoustic intensity pattern is created on the build platform with the desired geometry of the part or a portion of the part. These high intensity patterns are calculated in such a way to be coincident with the geometry of the desired part. At the locations of these high intensity patterns, UAMRs are created and the build material undergo fast phase transition from liquid to solid.

As shown in FIG. 10, the part is printed on a platform where in some embodiments of the invention the platform supports or enhances trapping of the UAMRs and increases the activity of the UAMRs and speeds up the phased transition to solid or semi solid state of the build material. The existence of such a physical platform is not always necessary for printing, other configurations according to embodiments of the invention having such a platform via integrating multiple holograms as discussed later such that an initial hologram forms a platform within the build material which then forms the platform upon which subsequent steps build.

As depicted within FIG. 10, both the hologram and build platform are submerged or immersed within the build material. However, it is possible to separate the hologram and the build platform via a transmitting medium. In this case, a build chamber is filled with the build material and both the build chamber and the hologram are submerged in a transmitting medium such as depicted in FIG. 11. For acoustic/ultrasound this medium may be water due to its low cost and generally having a lower X-wave attenuation coefficient than the build material such that increased power reaches the build platform of the build chamber.

Referring to FIGS. 12 and 13 there are depicted exemplary embodiments of the invention for direct printing of electrical circuit patterns using a printed circuit board (PCB) as the build platform. In these embodiments of the invention the build material is conductive after the phase transition to solid in order to form the electrically conductive tracks upon the PCB. For example, within embodiments of the invention conductive nanoparticles such as silver, gold, or carbon nano tubes (CNT) can be mixed within a resin background (such as poly (methyl methacrylate) (PMMA), polydimethylsiloxane (PDMS) for example) to create the build material. It would evident that magnetic nanoparticles may also can be incorporated into the build material as well to print multifunctional parts. Accordingly, embodiments of the invention can exploit conductive and/or magnetic build materials.

2B: Progressive Printing Via Moving Energy Source Assembly

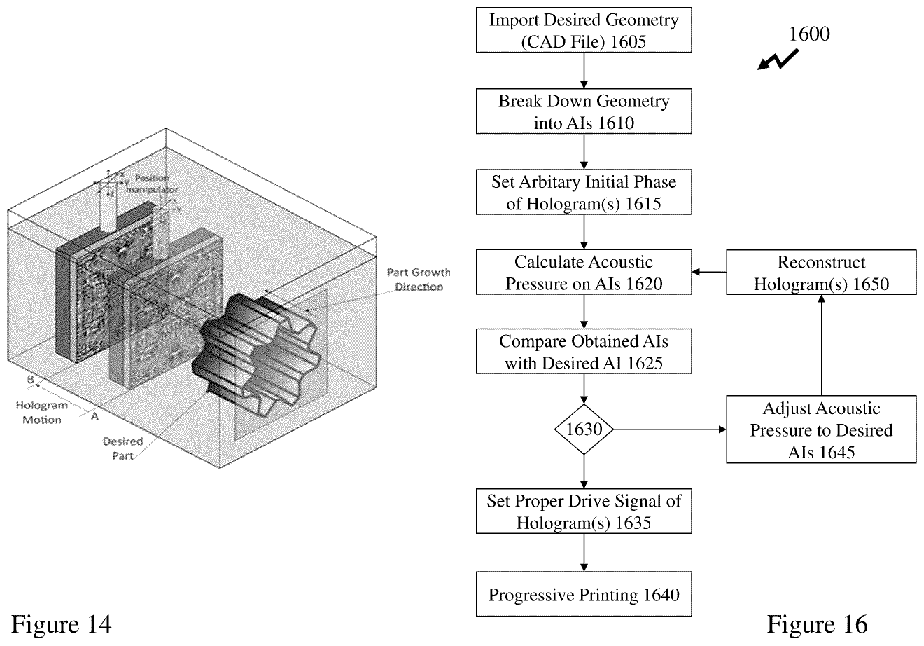

Within embodiments of the invention the three dimensional objects can be created progressively by moving the hologram discretely or in combination with the energy source via a positional manipulator such as depicted in FIG. 14. Within FIG. 14 the energy source/hologram are attached to one another but within other embodiments of the invention they may be separated and moved together or separate and moved independently. Accordingly, considering initially that the hologram is at location A as shown in FIG. 14. At this location, the hologram creates a pattern on the build platform. By moving the hologram smoothly from location A to B, the part is grown continuously from the platform and is “extruded” in the direction of the hologram motion progressively. The inventors using the term “extruded” within this context as being formed continuously as the hologram is moved rather than the conventional sense of the word. Accordingly, FIG. 14 shows a “vertical” extrusion wherein the growth of the part is in the direction of motion and normal to the nominal plane of the hologram. However, within other embodiments of the invention the method can be applied for extruding any two dimensional cross section along a trajectory established by the positional manipulator. At each position of the positional manipulator the hologram generates concurrently the portions of the part at that position. The hologram would then follow the trajectory of the positional manipulator with a controlled velocity and acceleration to allow for smooth formation of the part along the trajectory. Due to the speed of material formation achievable with UAMRs according to embodiments of the invention high positional motion of the hologram can be achieved to increase piece part growth speed, reducing manufacturing costs/time accordingly. Within subsequent depictions of embodiments of the invention in this Section 2 the build material and/or medium are omitted in order to simplify the Figures.

2C: Progressive Printing Via Fixed Energy Source Assembly

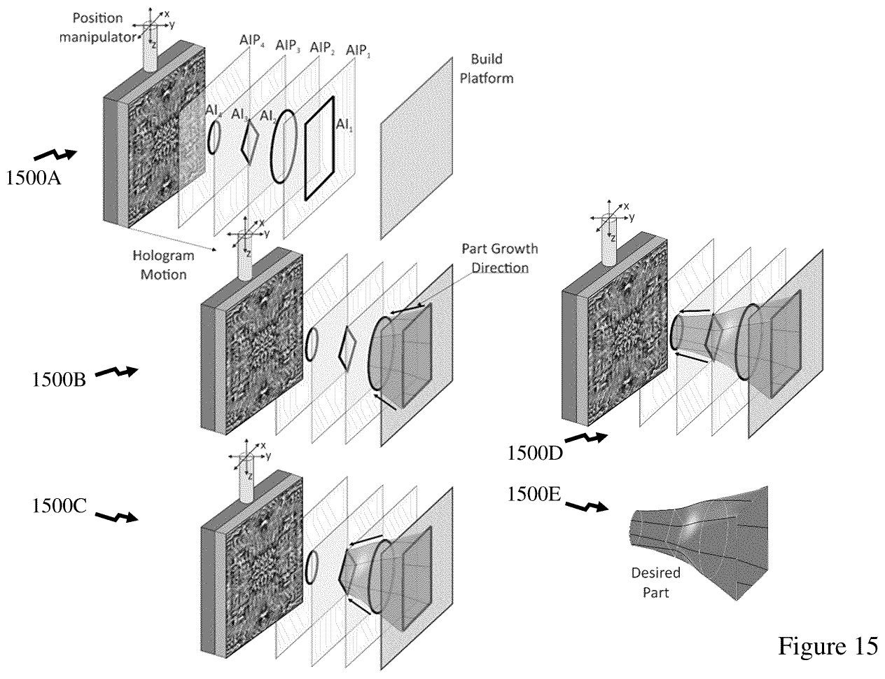

Within the preceding description with respect to embodiments of the invention the hologram has been described, implicitly rather than explicitly, as containing a single image. However, a hologram has the capability to store multiple images corresponding to various planes. These planes, when considering acoustic holograms, being referred to as Acoustic Image Planes (AIPs) and their images called Acoustic Images (AIs). Accordingly, a part with a variable cross-section may be discretized into many cross sections where each cross section can be stored in the hologram as an AI on an AIP. Accordingly, FIG. 15 depicts printing a multi-sectional object using a single hologram or meta-material within a “holographic” 3D AM printer according to an embodiment of the invention. Referring to first image 1500A four cross sections of a part, AIP₁; AIP₂; AIP₃; and AIP₄ are depicted as being stored within the hologram. These AIs are projected into different AIPs with different distances from the surface of the hologram.

The hologram is moved towards the build platform is such a way that AIP₁ is coincident with the build platform (second image 1500B in FIG. 15). The energy source is activated, e.g. switched on or a blocking element removed, and UAMRs are created at the location of the patterns created on the platform as defined by AIP₁. Then part growth is initiated and motion of the hologram undertaken, in this exemplary embodiment of the invention towards AIP₂ (second image 1500B in FIG. 15). Accordingly, this process continues such that as depicted in third and fourth images 1500C and 1500D the subsequent images upon AIP₃ and AIP₄ are employed so that the desired part is formed in sequentially and continuously as depicted in fifth image 1500E in FIG. 15. FIG. 15 schematically shows the method however, in reality, the part would be divided into many cross sections to achieve the desired accuracy of the produced part. However, due to continuous change of the virtual image in between two successive AIPs, if the change in AIs is not significant, the number of the stored images could be reduced. This is a promising aspect of this technology since there is continues change in the virtual images rather than binary existence of them.

Optionally, within other embodiments of the invention a hologram may contain multiple AIs each within a different AIP representing a specific geometrical configuration. Accordingly, with control of the energy source and hologram position these different geometrical configurations may be formed at different spatial positions upon the piece-part. For example, using the example described above of an electrical circuit upon a PCB one AI may represent the circular geometry around a via, a second AI a pad for an integrated circuit, a third AI a pad for a discrete electrical component such as an inductor, etc. Different motions of the hologram for each AI may accordingly result in different metallization thicknesses at each location.

2D: Progressive Printing on Platform

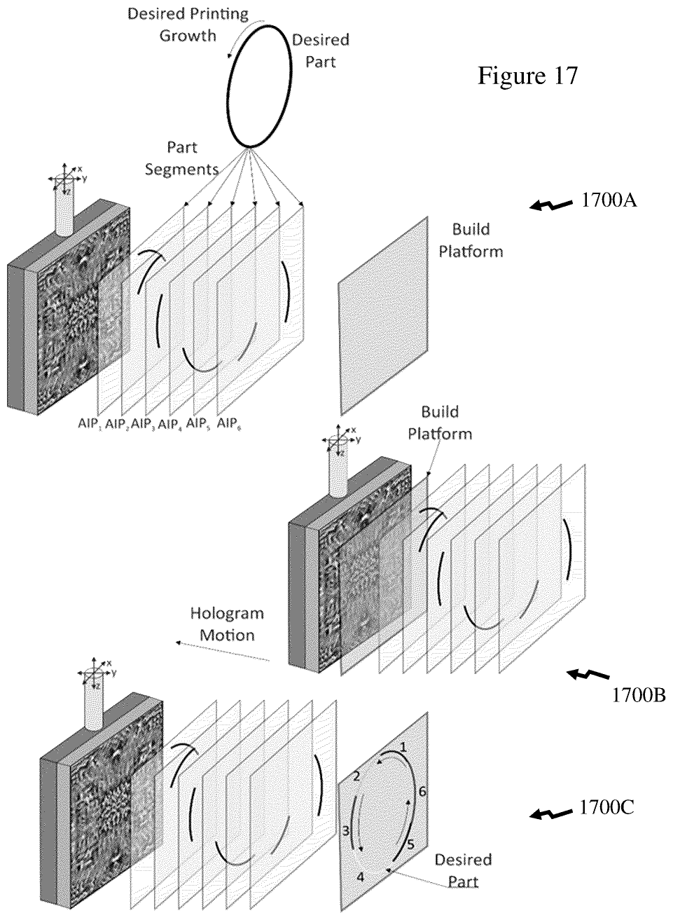

In another embodiment of the invention depicted in FIG. 17, a method according to an embodiment of the invention is depicted wherein a continuous pattern or patterns are printed onto the platform using multiple AIs stored within a single hologram. This method may also be employed also for particle manipulation in two-dimensional (2D) or three-dimensional (3D) space via physical barrier creation. Accordingly, as depicted in first image 1700A the desired part is discretized into a number of successive segments wherein the hologram is designed in such a way that these segments are projected onto successive AIPs. In other words, the desired part is distributed onto different AIPs in a predetermined order.

Then the hologram is moved towards the platform until all the AIs are “placed” towards the other side of the platform to that disposed towards the hologram, as depicted in second image 1700B in FIG. 17. Then the energy source is coupled to the hologram, i.e. switched on, directed to the hologram or unblocked, wherein the hologram is moved away from the platform via a position manipulator as shown between second and third images 1700B and 1700C respectively in FIG. 17 such that during this motion, one by one, each AI “passes through” the platform such that the AIs are created (solidified) on the platform. This creates a continuous solidification on the platform according to the pattern of the desired part. In other words, an observer would see that the patterns of the desired part are created successively as sections 1 through 6 from AIP₁ to AIP₆ respectively. Besides the application of continuous printing, this method can be used for particle manipulation when particle/s are moved by the continuously solidified region (i.e. a physical boundary) on the platform and pushed forward to where there is no physical boundary.

2E: Progressive Printing Via Multiple Moving/Fixed Energy Sources

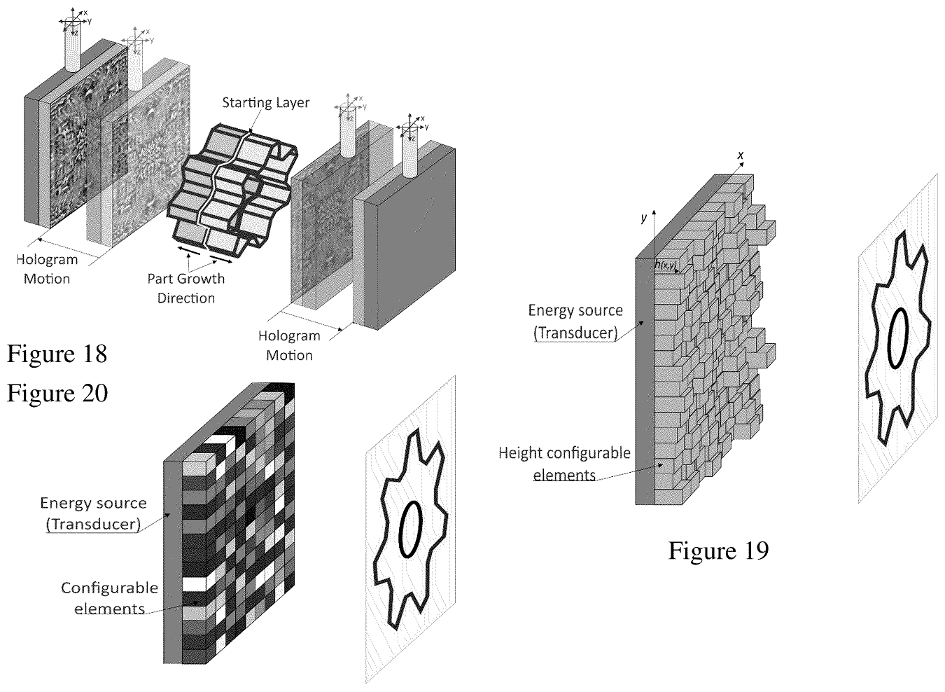

Within another embodiment of the invention, two or more holograms can be used to create interference of X-waves within the build chamber. At the location of these interferences, the UAMR clusters are trapped and/or solidified. In this method, a physical platform is not necessarily required as the trapping region(s) can perform the function of the physical barrier of the platform. For example, referring to FIG. 18 there is depicted schematically an embodiment of the invention wherein two holograms are placed face to face. When the two holograms are active (i.e. the energy sources coupled to the holograms are coupled to the holograms then at the region where the two AIs from the two holograms overlap the starting layer begins to be solidified. Subsequently, as depicted motion of the two holograms away from each other via motion manipulators is undertaken such that the holograms' motion moves the AIs away from the starting layer (assuming only one AI is stored in each hologram). During these motions, the both sides of the part undergo solidification and the part is grown in both directions progressively.

Within this embodiment of the invention the energy source at the plane within the build material defined by the AI is sufficient from each side such that UAMRs are formed by each AI as it moves. Optionally, within other embodiments of the invention the energy of each energy source is insufficient to trigger UAMRs such that is only where the AIs of the two (or more) holograms overlap that the UAMRs are triggered. Accordingly, consider the example of FIG. 18 both holograms would move together to keep the same spatial relationship such that the part is grown sequentially. Optionally, each hologram may contain multiple AIs within different AIPs so that these can be employed to form different concurrent growth geometries wherein the same AI may be in each hologram or different AIs may be stored within different holograms. For example, one hologram may contain a single square AI whilst the other hologram contains a ring, a circle, and a square. Accordingly, selection of the appropriate AIP in the other hologram means that when combined with the square AI of the first hologram the pair can print a ring, a square and a circle in that region of the building material where the two AIs overlap.

2F: Progressive Printing Via Active Hologram

Within the preceding embodiments of the invention described with respect of FIGS. 10 to 18 the holograms were passive. By passive, the inventors mean that the hologram cannot be changed in real time to project real time AIs, rather the AI(s) are preconfigured in the AIP(s) of the hologram. However, embodiments of the invention may exploit active holograms such as those depicted in FIGS. 19 and 20 which allow for an element or pixel within the hologram to be varied such that the resulting AI changes. Referring to FIG. 19 an exemplary active hologram according to an embodiment of the invention is depicted wherein the height of a pixel on the hologram can changed dynamically, i.e. in real time. Accordingly, the resulting thickness of the material through which the X-waves traverse within different pixels varies resulting in amplitude and/or phase shifts in the X-wave through the different pixels which can be exploited directly or in combination with X-waves from other holograms/energy sources to create the dynamic pattern at the predetermined plane or locations within the build material, e.g. upon the platform. Accordingly, the hologram is comprised of many micro-size elements (in the shape of cube, as shown in FIG. 19, or hexagonal, cylindrical, etc.) that their heights can be configured via direct material effects, e.g. piezoelectric materials such as lead zirconate titanate (PbZr_{X}Ti_{1-X}O₃, PZT) or polyvinylidene difluoride (PVDF), or through micro-actuators for example which are connected to a control system. The control system is connected to a computer where the required images are computed using holography theories/algorithms. Accordingly, in real time the elements can change their heights to create desired images at required locations. This offers significant flexibility over passive holograms where images are stored offline and cannot be changed.

As depicted in FIG. 10 according to another embodiment of the present patent, an active hologram is considered as many configurable elements where each element could have adjustable properties. For example, with acoustic or ultrasonic signals as the X-waves then this may be acoustic impedance. Accordingly, each different shade would represent a different acoustic impedance of that pixel. For an acoustic hologram, the acoustic properties of each element (pixel) could be changed via one or more factors including, but not limited to, pressure, temperature, magnetic field, electric field, or geometry. For example, each element could be filled with a magnetorheological fluids (MRFs) subjected to electric and/or magnetic fields. Due to the impedance modulations, the desired phase map of the surface of the active hologram can be achieved. Electric/magnetic field of each element is controlled by a control system connected to a computer that in real time send commands to control system to vary the electric/magnetic field and consequently change the acoustic impendence and phased on each element.

2G: Case Studies

Referring to FIG. 16 there is depicted an exemplary flowchart 1600 for generating a part using an acoustic energy source with progressive printing in conjunction with a holographic 3D AM printer exploiting a hologram or meta-material according to an embodiment of the invention. Whilst the flowchart 1600 is described with respect of acoustic signals it would be evident that the process can be employed with other X-waves. Accordingly, the flowchart 1600 comprises first to eighth steps 1605 to 1640 with a loop comprising ninth and tenth steps 1645 and 1650, respectively. Accordingly, first to eighth steps 1605 to 1640 comprising:
First step 1605 wherein a computer aided design (CAD) file is imported relating to the part to be manufactured;
Second step 1610 wherein the geometry of the part defined by the CAD file is broken down into AIs;
Third step 1615 wherein an arbitrary initial phase for the hologram is defined;
Fourth step 1620 wherein the acoustic pressure for each AI is calculated;
Fifth strep 1625 wherein the obtained AI for the hologram is compared to the target AI defined from the CAD file;
Sixth step 1630 wherein it is determined whether the obtained AI is acceptable or not where if it is not the process proceeds to the loop otherwise it proceeds to seventh step 1635;
Seventh step 1635 wherein the appropriate drive signals for the hologram are set; and
Eighth step 1640 wherein progressive printing is undertaken using the AIs in conjunction with any motion of the hologram as required to generate the part defined by the CAD file.

For the loop then ninth and tenth steps 1645 and 1650 comprise:
Ninth step 1645 wherein the acoustic pressures are adjusted to the desired AIs; and
Tenth step 1650 wherein the hologram is reconstructed after which the process proceeds back to fourth step 1620.

In the following case studies, the capability and potential of the presented patent are shown by examples.

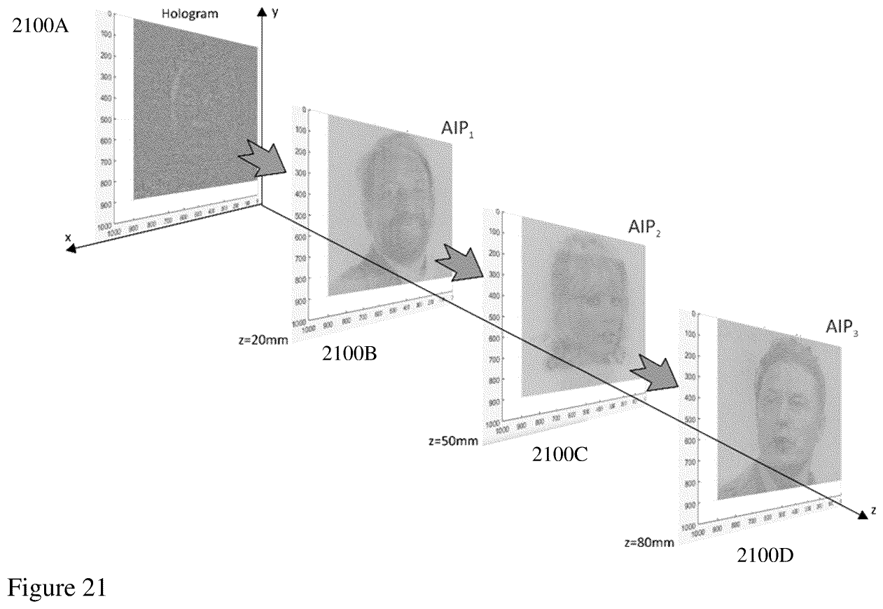

Case I: In this case study an acoustic hologram is designed to store three complex images as depicted in FIG. 21 wherein schematically multiple complex images, first to third images 2100B to 2100D respectively, are stored within a single hologram 2100A or metal-material to provide the hologram or meta-material within a holographic 3D AM printer exploiting a hologram or meta-material according to an embodiment of the invention; This case study demonstrates how complex the images can be where the different AIs have planes 20 mm, 50 mm and 80 mm away from the hologram 2100A.

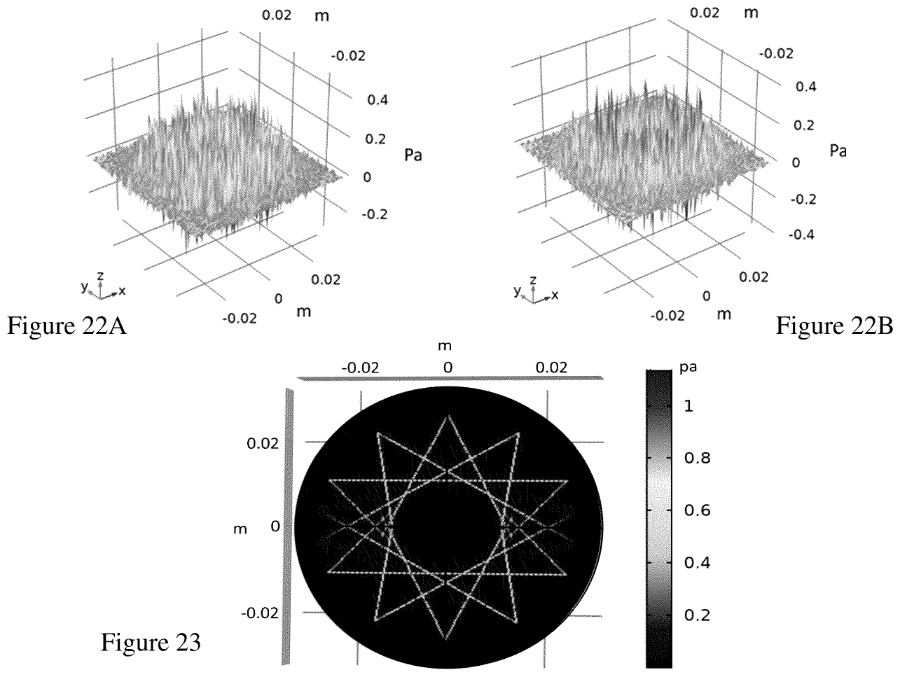

Case II: An acoustic hologram is designed based on flowchart presented in FIG. 16 to create a star symbol 5 mm away from the surface of the hologram. The real and imaginary parts of the surface pressure of the hologram are depicted respectively in FIGS. 22A and 22B where the hologram surface is the X-Y plane whilst FIG. 23 depicts the resulting hologram pattern generated at Z=5 mm with these real and imaginary parts of the surface pressure of the hologram. FIGS. 22A to 23 being generated through finite element simulations.

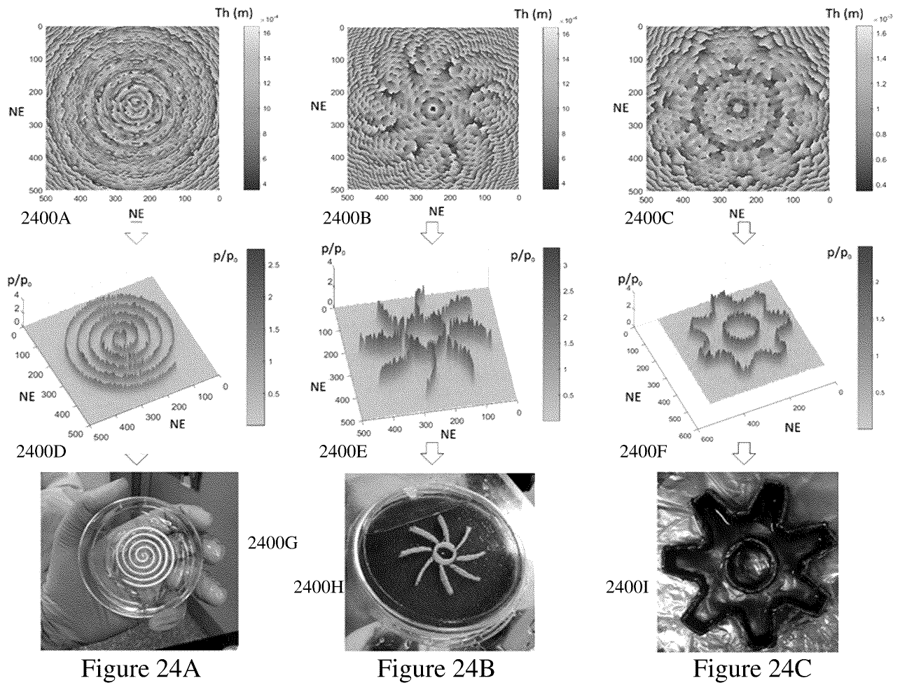

Case III: In this case study, holograms of three different geometries were designed using the developed algorithm described and depicted with respect to FIG. 16. Accordingly referring to FIGS. 24A to 24C respectively there are depicted:
first to third images 2400A to 2400D depict the hologram thickness for each of the three shapes, a spiral, an impeller, and a gear;
fourth to sixth images 2400D to 2400F depict the resulting simulated pressure pattern at a distance of 50 mm from the surface of the hologram; and
seventh to ninth images 2400G to 24001 respectively of the resulting printed parts.

The liquid resin employed was silicon based with an ultrasound frequency of 3 MHz.

3: Nozzle Based Localized Ultra Active Micro-Reactor (UAMR) Additive Manufacturing (UCON-249)

Amongst the prior art Additive Manufacturing (AM) processes is Fused Deposition Modeling (FDM) wherein, predominantly, a thermoplastic filament is melted using a heater at the tip of nozzle wherein the softened (or molten) thermoplastic is “stuck” to the preceding layer or platform. Other embodiments exploit UV curing of UV curing resins such as acrylated epoxies, acrylated polyesters, acrylated urethanes and acrylated silicones. However, as described previously the processing times, heating zone, illumination region etc. result in HAZ+ AM processing.

Accordingly, the inventors have sought to establish HAZ− AM processing where the energy excitation time, Δtₑ is significant shorter than any process transfer time to the surrounding medium, Δtₘ, i.e. Δtₑ<<Δtₘ. Accordingly, the inventors have established AM processing methodologies based upon the excitation time, Δtₑ, being on the order of nanoseconds compared to the millisecond to microsecond cooling rates, Δtₘ, of the medium. The energy is concentrated mainly to the center of applied energy region (reactor) leading to a sudden and rapid rise of temperature/pressure at the center of the reactor and a sharp drop in temperature/pressure away from the center. As a result, the surrounding medium will not experience phase transformation beyond the center region of the reactor where the temperature and pressure rise are within a distance, of the order of nanometers, with respect to the center. These reactor being referred to by the inventors as Ultra Active Micro-Reactors (UAMRs) due to these extreme conditions which results in negative heat affected zone (HAZ−).

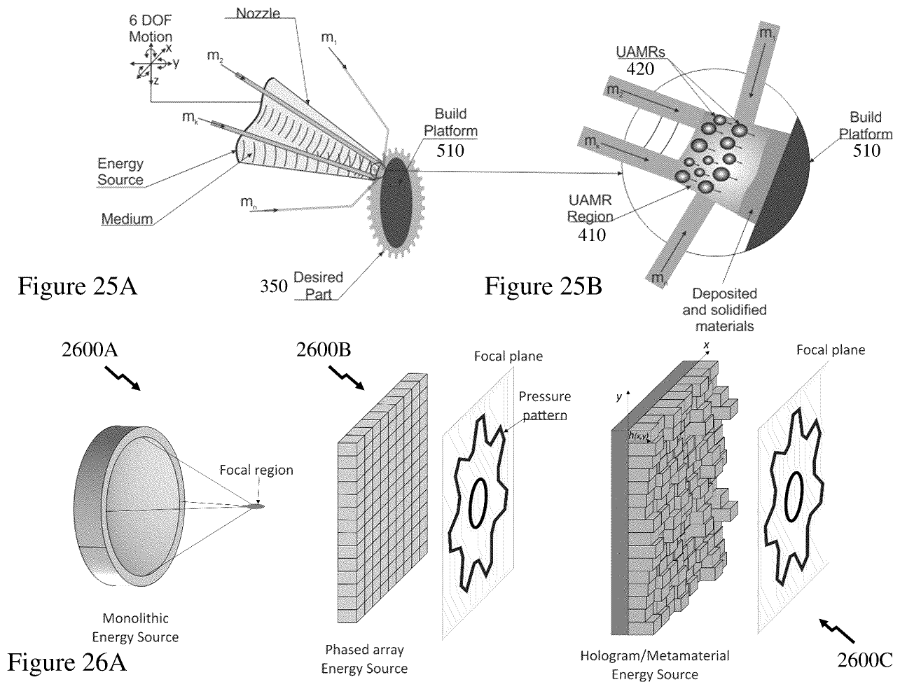

Referring to FIGS. 25A and 25B there are depicted schematically a compact mechanism generally and in detail view for forming a part using a 3D AM printer exploiting a nozzle based compact mechanism in conjunction with UAMRs according to an embodiment of the invention. Accordingly, within embodiments of the invention as depicted in FIG. 25A the transmitting medium is placed in a confined chamber (nozzle) wherein the transmitting element(s) transmit the X-wave(s) to the tip of the nozzle where multiple materials, m₁, m₂, . . . , mₙ can be injected at the UAMR region as shown in the detailed view in FIG. 25B. The nozzle within embodiments of the invention can move around the build platform and deposit the materials on it. Accordingly, the nozzle can be attached to a position and orientation manipulator as shown in FIG. 25A to move around the Build Platform 510 to generate the desired Part 350. Optionally, the nozzle may be fixed and the Build Platform 510 attached to a position and orientation manipulator to allow its movement relative to the nozzle. Optionally, the nozzle and platform may both be mounted to positional and orientation manipulators. Which configuration is employed may be determined by the X-wave wherein, for example X-rays might suit a fixed nozzle configuration whereas electron beam irradiation may suit a movable nozzle configuration.

3A: Overview

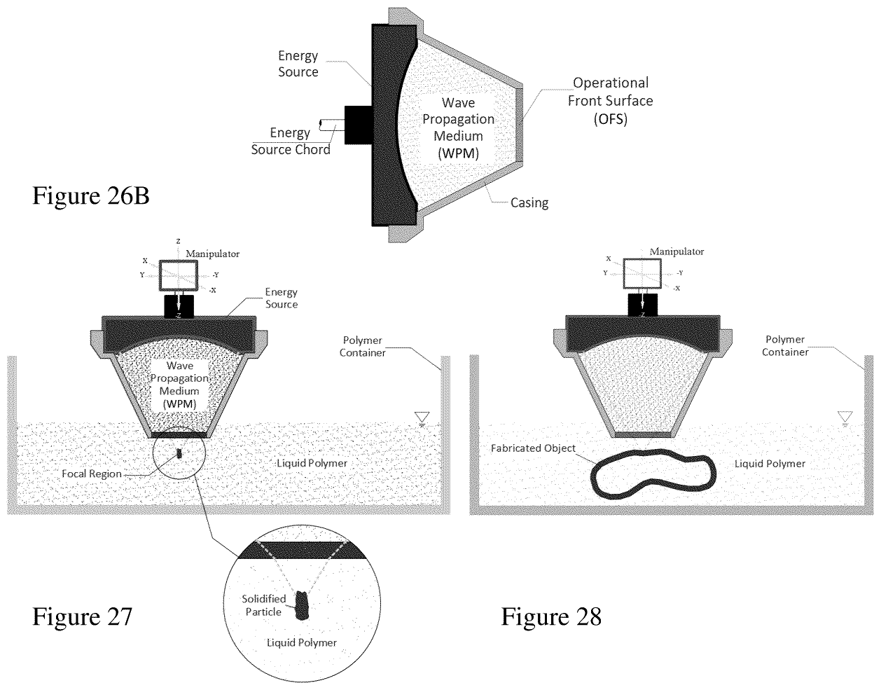

Within embodiments of the invention a focused energy source is employed to generate the X-waves focused at a specific point which is called a Focal Volume. Depending upon the structure of the device as well as nature of the X-wave, this focal volume could be in different shapes such as point, sphere, oval, line etc. with negligible depth or some depth such that the Focal Volume may be essentially two-dimensional (2D) or limited three-dimensional (3D). Usually a focused energy source such as monolithic energy source depicted in FIG. 26A in first image 2600A has a parabolic surface at the plane of X-wave generation to focus the X-waves. Alternatively, as depicted in second image 2600B a phased array energy source may be employed generating a complex multi-focal region and simple patterns, e.g. optical or acoustic patterns for example, can be achieved. Using active holograms, complex pressure X-wave patterns can be generated in the medium such as depicted by third image 2600C in FIG. 26. For the sake of simplicity and uniformity of the presentation of the methods within this Section 3 a single monolithic energy source is considered in the description and depiction of the Figures. However, other type of energy sources like phased array, holograms or metamaterial can be used interchangeably.

Exploiting energy at a specific point by a focused energy source has allowed the inventors to demonstrate an embodiment of the invention for an AM system which exploits solidifying thermoset liquids at an arbitrary point in a space. FIG. 26B depicts a schematic of a focused energy source (FES) nozzle (FES nozzle) according to an embodiment of the invention for using within a 3D AM printer according to an embodiment of the invention. The FES nozzle (or nozzle) consists of an energy source (actuator or transducer) generating X-waves, a X-wave (wave) propagation medium (WPM), a casing as well as an operational front surface (OFS). The energy source is the device to supply required focused energy for performing the AM operation by triggering the UAMRs. Achieving the desired size and resolution for the final solidified spot strongly depends upon the source characteristics. The WPM is an adjacent space to the source and extends close to the focal region. In the other words, this area surrounds most of the X-wave propagation in a conic region but does not include the focal region. It could be solid or liquid and is the medium through which the generated X-wave are transmitted to the OFS. This material should possess an excellent X-wave transmission characteristic to impose a minimum energy loss to the passing X-wave.

The casing is a designed object that encompasses the energy source and WPM and separates the system from the external environment. The casing material should possess an X-wave absorbance sufficient to absorb any stray or reflected X-waves to prevent them penetrating other regions of the AM system. One or more material transmission channels (MTCs) could be installed individually in the AM system device or embedded as part of the casing of the nozzle. The MTC or MTCs transport the operational build material through the system. The OFS is the front face of the device that is in contact with the external medium which is an operational liquid. The same as WPM, OFS should have suitable X-wave transmission characteristic as well. Depending upon the type of nozzle the OFS could be flat, concave, convex or have another geometry.

Within embodiments of the invention build materials may comprise thermoset liquid resins, light cured resins, solid plastic filaments, plastic coated nanoparticles as well as metallic nanoparticles suspended in thermoset resins etc. Build materials within embodiments of the invention may be liquid, powder, slurry, solid filament etc. which can be transferred to the nozzle via the MTC(s) under control of external injection pump, feeder etc. The rate of feeding and any preconditioning of the material may be established according to the requirements of the AM process.

3C: Process

Considering an embodiment of the invention established by the inventors as a proof of principle prototype AM system the nozzle is deployed within a build material comprising polymer resin wherein the acoustic X-waves transmit into the fluid (liquid polymer resin) after passing through the WPM and OFS wherein they focus at the focal point external to the nozzle within the liquid polymer. Accordingly, the resin exposed to acoustic energy at the solidifies due to heat generation at this point. Magnitude of temperature rise, amount of and heat transfer as well as polymerization's time depends on the thermoset resin's material property. By continuing the process bulk of solid polymer can be formed inside the liquid resin. This means that by conducting the process based on a predesigned shapes or patterns fabrication of 2D or 3D objects can be formed directly within the liquid polymer. Within embodiments of the invention the nozzle can be manipulated either manually or robotically by employing a CNC machine, robotic arm etc.

FIG. 27 depicts the focused energy source (nozzle) as depicted in FIG. 26B deployed within a 3D AM printer according to an embodiment of the invention wherein the focused energy source is embedded within a polymer resin. FIG. 28 depicts the methodology of printing 2D or 3D parts using the focused energy source and 3D AM printer according to embodiments of the invention as depicted in FIG. 27.

3D: System Configurations

3D1: Type I. Apparatus without Injection

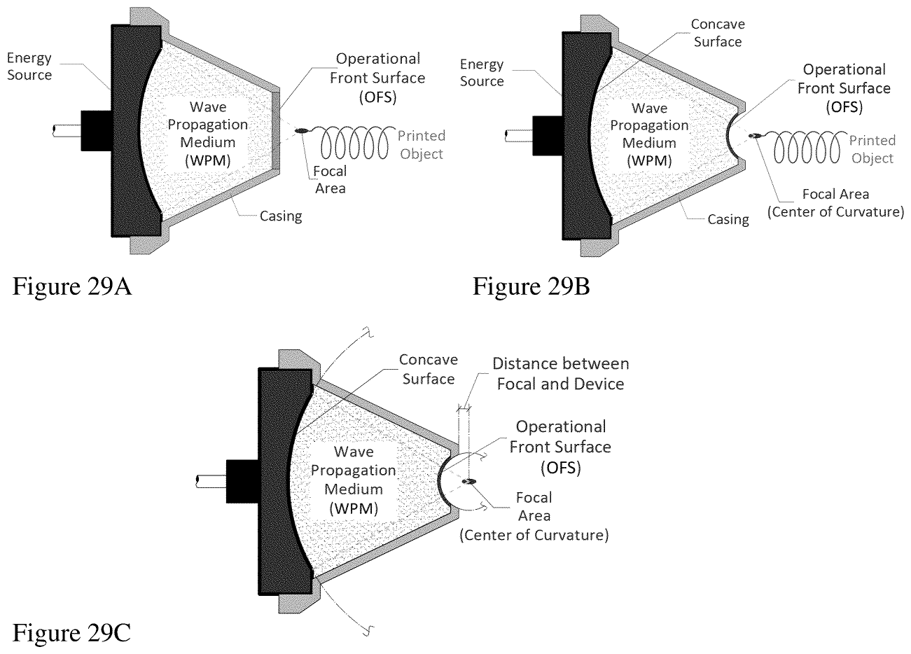

Referring to FIGS. 29A to 29C there are depict focused energy sources according to embodiments of the invention to provide different configurations of an operational front surface of the focused energy source.

The general form of the device is similar to that depicted in FIG. 26B wherein depending upon the application the OFS could be selected as a flat (FIG. 29A) or concave surface (FIGS. 29B and 29C respectively). By implementing the concave form of OFS energy loss of the system will be decreased due to lower X-wave reflection in the casing which can be addressed as an advantage of concave OFS device over the other. As depicted in Figures

As shown in FIGS. 29A and 29B, in this type of device, either flat or concave OFS, the focal point forms at outside of the device is close to the end surface of the casing. The location of OFS center coincides with the focal point which is the center of curvature of concave face of energy source although this does not have to be the case. If it is, however, the generated X-waves pass through the OFS with no refraction along the surface of the OFS as they impinge at perpendicularly to the OFS. In addition, the size of the OFS cap is identified by the location of the focal point with respect to the device as it is shown in FIG. 29C.

As described above with respect to FIGS. 27 and 28 by immersing the system in a functional resin and performing movement based on a predefined pattern using a mechanical manipulator such as a CNC tool, 3D objects could be fabricated within the bulk liquid resin due to polymerization of resins at the focal region. In this manufacturing process, by taking advantage of resin's viscosity and buoyancy force, fabrication of self-supported objects without any need for constructing additional support would be feasible. In addition to mentioned manufacturing process, fabrication of 3D object based on conventional layer by layer additive manufacturing process is possible. In this method the object will be built over a substrate immersed in a resin container.

When the propagated X-waves within the WPM reach the OFS part of incident X-waves will reflect back into the WPM and may be incident with the casing and, at this time, reflect from the casing walls into the WPM. This can cause increase in pressure and temperature of the WPM. Therefore, casing should be fabricated from the material which has an excellent X-wave absorption property, in order to reduce the effects of reflections inside the WPM. Since before X-wave convergence at focal they travel through the WPM and OFS, these objects should have the minimum impedance against the transmission of the X-waves. The OFS could be made from solid materials such as glass or plastics. In contrast, depends on a nature of the X-wave, the WPM could be either a solid, a liquid or a gas.

3D2: Type II: Apparatus with Injection Channels Embedded in Casing

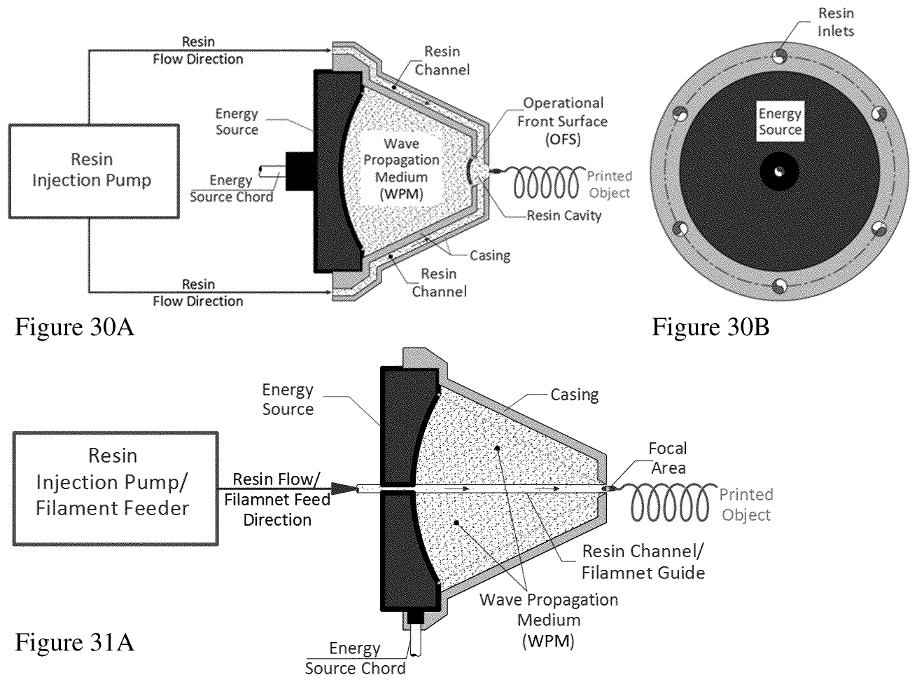

Referring to FIGS. 30A and 30B there are depicted cross-sectional and end views respectively of focused energy source print nozzle with a resin injection channel according to an embodiment of the invention applicable for fabrication of objects over a substrate with no need for bulk of resin. This eliminates the necessity of a polymer container and reduces the resin consumption. By using an external liquid pump, the resin/resins are injected into channels which are embedded inside the casing and conducted toward the resin cavity at the front side of OFS where the focal point forms. Other structural parts of this device are the same as the device described and depicted in FIGS. 29A to 29C, respectively.

In order to control the resin flow inside the resin cavity, more than one resin tube/channel could be used simultaneously. This configuration of device also provides the possibility of using multiple resins during the fabrication process which are combined at the point of use. Since the objects are built over a substrate, layer by layer, construction of additional supports during the process of fabrication is unavoidable. In addition to fabrication of 3D objects, this device can be used for coating of the surfaces with the layer of selected resin. Optionally, other deployment methodologies of the liquid/powder/slurry may be employed including, for example, thermal drop-on-demand (DOD) and piezoelectric DOD.

Type III: Apparatus with Central Resin Injection Channel

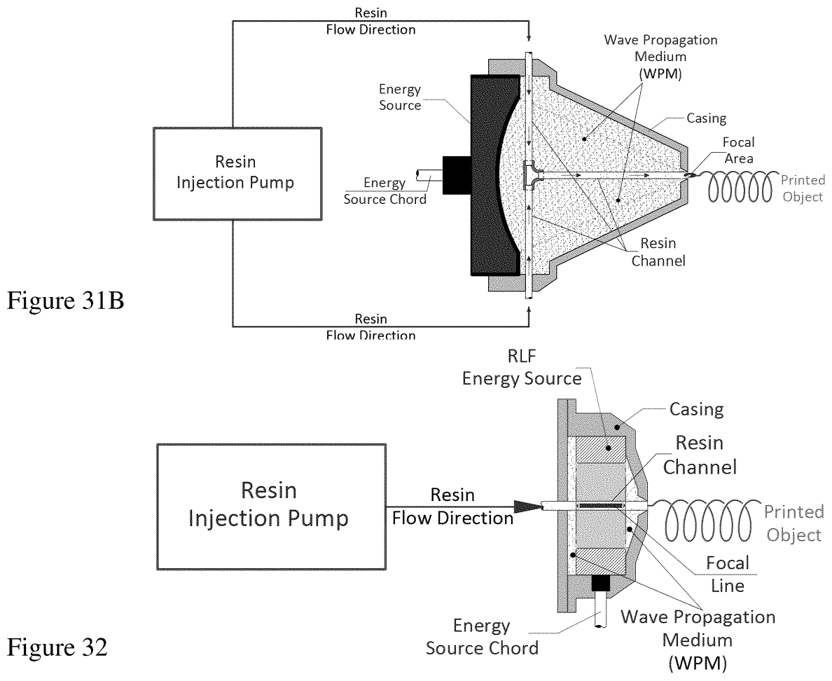

FIGS. 31A and 31B depict cross-sectional views of focused energy source (FES) print nozzles with a central resin injection channel according to an embodiment of the invention. In each the injection channel is at the center. Assuming a resin, then the resin flows through the center to the focal area. The focal point forms at the tip of the channel and the resin flow pushes out the polymerized resin which can stick over the surface of substrate. By continuing the process and moving the device manually or by using automated manipulators such as CNC, 3D objects can be fabricated layer by layer. Other structural elements of the device are the same as last two introduced devices. Optionally, other deployment methodologies of the liquid/powder/slurry may be employed including, for example, thermal drop-on-demand (DOD) and piezoelectric DOD.

Within these configurations in addition to usage of liquid/powder/slurry a solid filament can be utilized as the printing material, particularly with the nozzle depicted in FIG. 31A. By pushing the filament to the tip of the nozzle, part of material which locates at the focal area will melt due to generated heat at this point and can flow over the printing substrate. By dissipation of the heat to the surrounding area the melted material will become solidified again. Therefore, by continuing this process fabrication of the 3D object is possible.

Type IV: Apparatus with Ring Type Line Focused Energy Source

In this configuration of the nozzle apparatus, by substituting the ring type line focused (RLF) energy source with spherical type the focal area will change to the line of energy focused at the focal area which helps in increasing the volume of solidified or melted printing material at a time of energy exposure. All other parts of the device are the same as configuration “Type III”. The usage of ring type energy source decreases the flux of reflected X-waves induced by inappropriate incident angle while penetrating into the resin channel wall. Decreasing the size of apparatus is another advantage of implementing RLF energy source. FIG. 32 depicts a cross-sectional view of a FES print nozzle with a central resin injection channel exploiting a ring type line focused (RLF) energy source according to an embodiment of the invention.

Type V. Multi-Nozzle Head

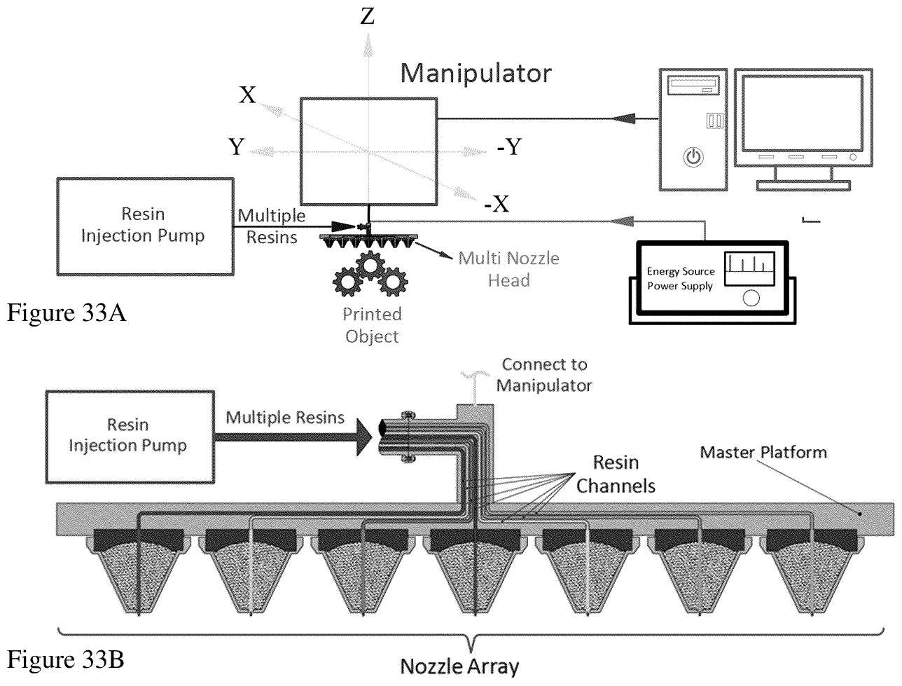

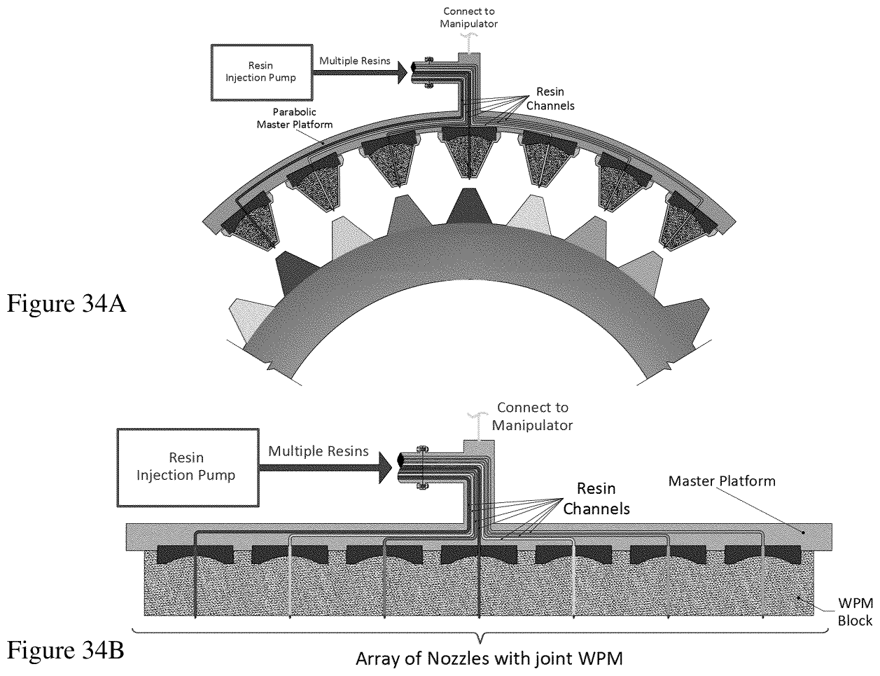

Multi-nozzle head (MNH) configurations may be employed to fabricate 3D objects which include multi parts made from different materials. FIG. 33A depicts an exemplary schematic of a 3D AM printer according to an embodiment of the invention exploiting FES print nozzles together with the related setup applicable for performing the fabrication process. The 2D or 3D array of nozzles are installed on a flat or shaped form of the master platform. FIG. 33B depicts an exemplary flat print head in cross-section for a 3D AM printer such as depicted in FIG. 33A exploiting focused energy print nozzles according to an embodiment of the invention. FIG. 34A depicts an exemplary shaped print head in cross-section for a 3D AM printer such as depicted in FIG. 33A exploiting focused energy print nozzles according to an embodiment of the invention. The sequence of nozzles activation performed is based on the predesigned CAD model and controlled by a dedicated central process unit (CPU). Depending upon the number of required materials, multiple nozzles can be assembled on a master platform to allow deployment of each material for the part without moving to a second system etc. Optionally, arrays of nozzle sets may be employed such that single positional manipulator can move multiple arrays such that multiple parts are fabricated simultaneously. In order to supply a material to nozzles a channel would be dedicated to each individual nozzle from a reservoir of that material or a series of channels to nozzles for the same material coupled to a single common reservoir of the material. Alternatively, as depicted in FIG. 34B an exemplary print head for a 3D AM printer such as depicted in FIG. 33A is depicted in cross-section exploiting a combined focused energy print nozzle assembly according to an embodiment of the invention wherein the nozzles and channels are fabricated within a single common block rather than being an array of discrete nozzles.

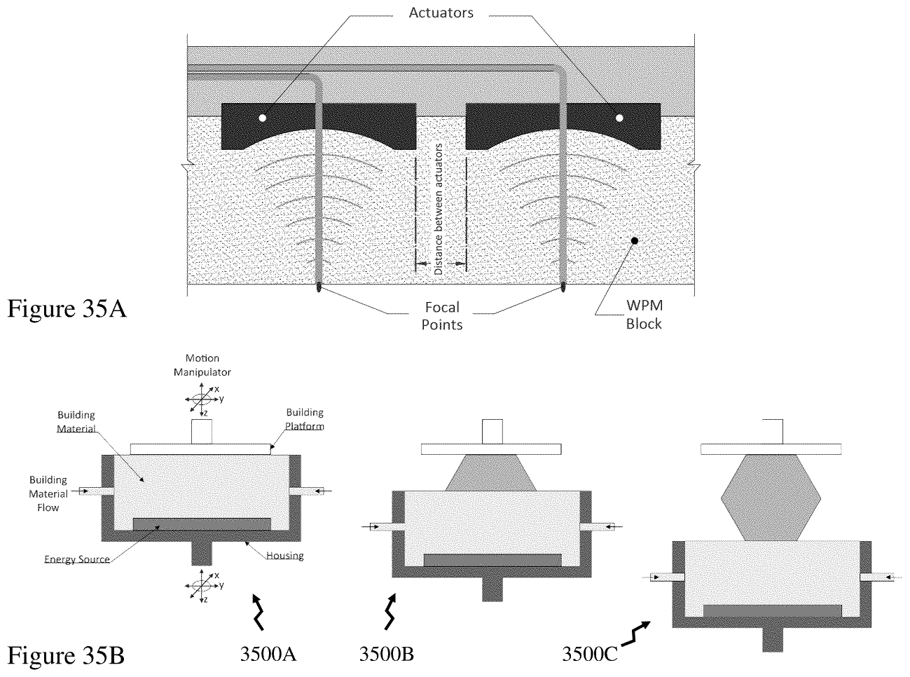

As the generated X-waves by each actuator propagate in a conic form through a WPM, by adjusting the distance between energy sources the interference of propagated X-waves can be decreased, as it can be seen in FIG. 35A wherein there is depicted schematically the arrangement of a pair of adjacent FES print nozzles within the print head depicted in FIG. 34B. Accordingly, each set of X-waves can converge at the tip of resin channel which is located at the focal point without getting influenced by other X-waves.

In each of these configurations depending upon the size of the desired object as well as variety of the build material(s) either an individual or multiple nozzles could be run at the same time.

Type VI: Open Nozzle Printer

In this embodiment of the invention an open design housing is introduced to print onto a platform. The platform and/or the nozzle (housing) can be moved by the motion manipulators. Referring to FIG. 35B this open housing design according to an embodiment of the invention for printing on a platform within a FES print nozzle or print head is depicted according to an embodiment of the invention. Referring to first to third images 3500A to 3500C the sequence of printing is shown. As depicted the building material is injected from the channels wherein the flow inside the channels may be synchronized with the motion of the platform and/or the housing. Accordingly, the part is formed and “pulled” from the building material.

3E: Prototype System

In order to investigate and prove design concept of embodiments of the invention the inventors designed and built a prototype of the apparatus classified as a “Type III” where the nozzle has a central injection channel.

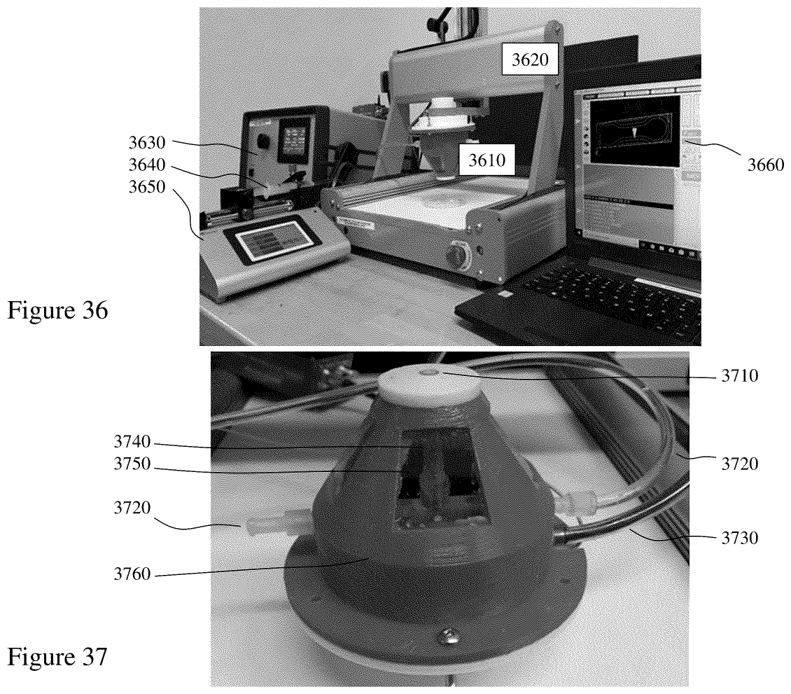

FIG. 36 depicts the experimental prototype system exploiting a FES print nozzle according to an embodiment of the invention consisting of a CNC manipulator 3620 upon which the Nozzle 3610 is mounted. Also depicted are build material reservoir 3640 which is connected to the Nozzle 3610 via tubing and to an Injection Pump 3650 which controls injection of the build material. Also depicted are the Acoustic Driver 3630 for the high intensity focused ultrasonic (HIFU) transducer within the Nozzle 3610 and the Computer 3660 controlling the system. FIG. 37 depicts an optical micrograph of a prototype FES print nozzle according to an embodiment of the invention comprising:
Build material discharge opening 3710;
Build material supply channels 3720;
HIFU transducer cable 3730;
Central build material channel 3740;
Sight glass 3750; and
Casing 3760.

The HIFU transducer was selected as the Nozzle's energy source and is fabricated from a piezoceramic material which is a spherically focused transducer in order to focus the ultrasound X-waves at a focal point. The transducer characteristics are represented in Table 1 below. Since the HIFU was embedded in the Nozzle 3610 it is not visible in the FIG. 37.

TABLE 1
HIFU Transducer Characteristics

| | Focal | Focal | Aperture | Hole |
|---|---|---|---|---|
| Frequency | Length | Region | Diameter | Diameter |
| (MHz) | (mm) | (mm) | (mm) | (mm) |
| 2.15 | 63.2 | 5.33 × 0.70 | 64 | 22.6 |

| Maximum | Maximum | Maximum | |
|---|---|---|---|
| Pressure at | Pressure at | Input | Power |
| Focal Region | Focal Region | Power | Efficiency |
| (W/cm2) | (MPa) | (W) | (%) |
| 54695.36 | 40.24 | 218 | 85 |

As the HIFU transducer selected was originally intended for biomedical applications the WPM within the prototype nozzle was water. Within the prototype Nozzle 3610 four sight glasses 3750 were embedded in the Casing 3760 in order to allow observation of the process during the performance of the device. The Acoustic Driver 3630 was employed to supply the required power by HIFU and could provide a maximum power of 218 W for the range of frequencies between 2.00 MHz and 2.49 MHz. The CNC Manipulator 3620 allowed manipulation of the nozzle in the standard 3 axis Cartesian coordinate system (X, Y, Z). Within this prototype system the resin employed was polydimethylsiloxane (PDMS) such that the HIFU transducer is required through the ultrasonic signals to cure the resin through a thermoset process.

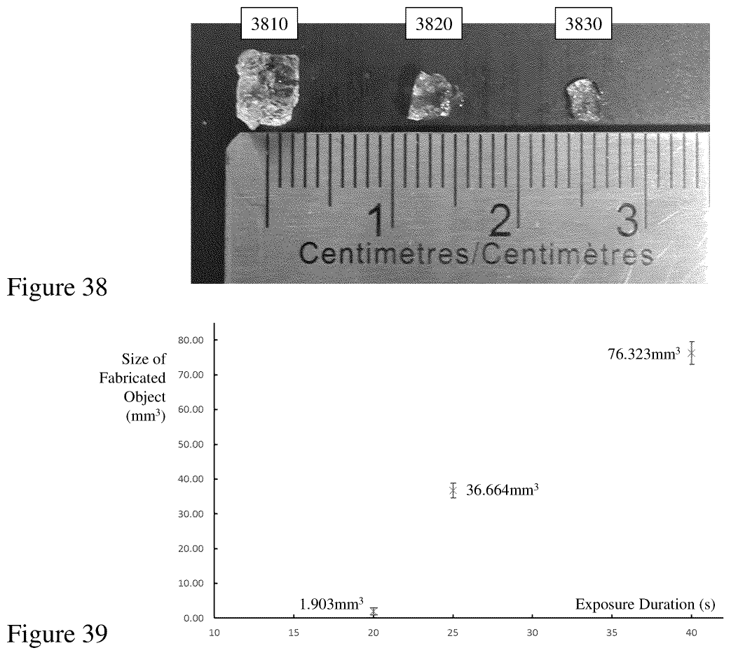

Accordingly, the HIFU transducer was operated at 2.15 MHz frequency with 218 W watts supplied power whilst the PDMS resin was transferred to the nozzle at 3 different flow rates of 1.910, 1.470 and 0.095 mm³/s for durations of 40, 25 and 20 seconds respectively. After running the transducer that portion of the PDMS exposed to the ultrasound energy at the focal area will be solidified and discharged from the tip of the nozzle under the pressure of resin flow. FIG. 38 depicts the resulting printed parts using the prototype FES print nozzle of FIG. 37 wherein first to third parts 3810 to 3830 represent the flow rates of 1.910, 1.470 and 0.095 mm³/s for durations of 40, 25 and 20 seconds respectively. FIG. 39 depicts the printed part volume versus time of printing using the prototype FES print nozzle of FIG. 37 wherein the respective volumes for the parts with flow rates of 1.910, 1.470 and 0.095 mm³/s for durations of 40, 25 and 20 seconds respectively were 76.323 mm³, 36.664 mm³ and 1.903 mm³ respectively.

All printed parts which have been fabricated during these processes had a cylindrical shape with the transparent nature. The observations and dimensional measurements of printed objects are outlined in Table 2.

TABLE 2
Observations and Dimensional Measurements
of Prototype Nozzle Printed Parts

| Exposed Time (s) | 40 | 25 | 20 |
|---|---|---|---|
| Flow Rate (mm³/s) | 1.910 | 1.470 | 0.095 |
| Part Shape | Cylindrical | | |
| Length (mm) | 4.737 | 4.013 | 3.060 |
| Diameter (mm) | 4.530 | 3.417 | 0.890 |

4: Standing Wave and Focused Wave Ultra Active Micro-Reactor Printers (UCON-250)

In this section mechanisms are presented based on controlling and manipulating UAMRs such as described above based upon standing X-waves and focused X-waves. Within the standing X-wave-based mechanism, UAMRs can be nucleated externally or internally. In focused X-wave-based mechanisms, UAMRs are created internally during the process. All mechanisms generate UAMRs at the desired location in the build material for solidification/printing. However, due to kinematic configuration differences of each mechanism, their performance is different.

4A: Standing X-Wave Based Printer

In this embodiment of the invention, discrete energy source radiate X-waves into the build chamber and due to interference of the X-waves, UAMRs are trapped in selective locations in the build chamber. UAMRs can be nucleated externally in the standing X-waves.

4A1: Static Energy Sources

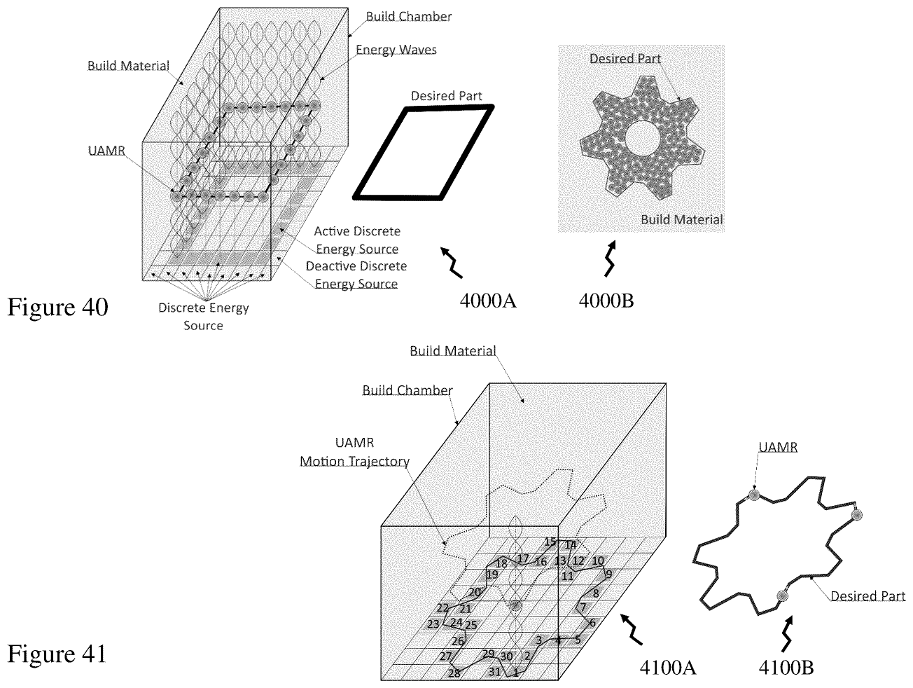

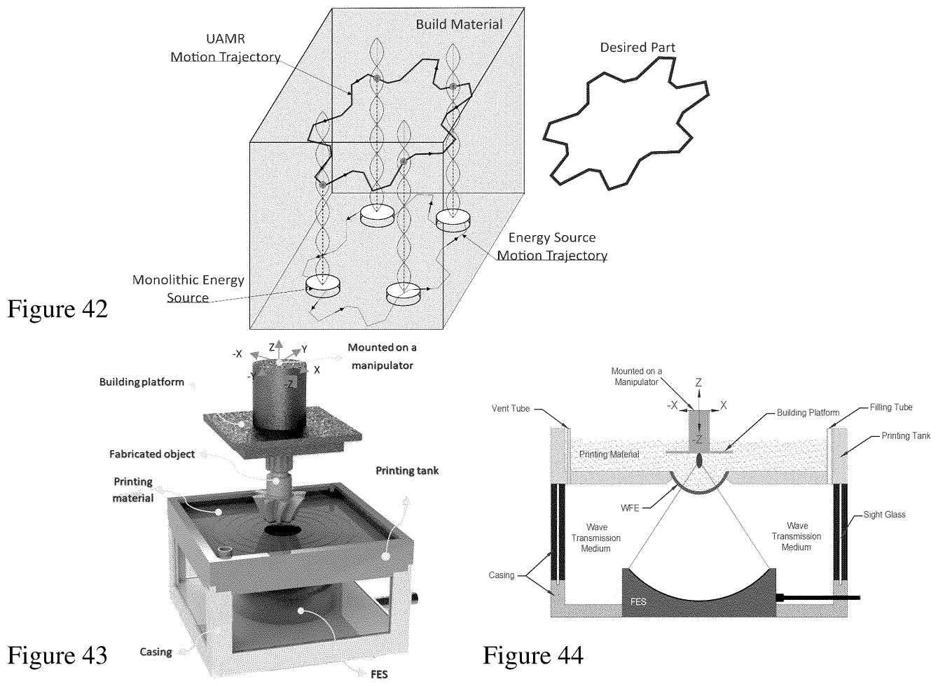

Due to fast phase transition from liquid to solid at these locations, the build material is solidified, and the desired shape is created as shown in first image 4000A in FIG. 40. Accordingly, one or more faces of the build chamber could be covered with discrete transmitting elements in which each of them is connected to the pulse generator/amplifier. Phased array transducers are one kind of these discrete elements. Based on the geometry of the desired part, each transmitting element can be activated or deactivated. Accordingly, as depicted in second image 4000B in FIG. 40 another strategy for filling the desired geometry with UAMRs is to solidify the UAMR regions in the desired geometry for the part which according to the number of transmitter elements, their design, energy etc. could all be concurrently produced, produced sequentially or a number concurrently produced in sequential sets.

4A2: Dynamic Energy Sources

FIG. 41 shows another embodiment of the invention in which each transmitting element is selectively and sequentially switched on/off to move the UAMR region along a trajectory, which creates the desired part. As shown in first image 4100A in FIG. 41 the sequence of switching on/off of the transmitting elements is depicted which thereby moves or forces the UAMR to move along the desired trajectory in the build chamber to create the desired part as depicted in second image 4100B.

Another embodiment of the dynamic trapped UAMR printing can be pictured by moving the monolithic energy source or monolithic hologram of the energy source as depicted in FIG. 43. The energy source can be moved by a motion manipulator wherein beneficially this configuration reduces the requirements for multiple energy source and associated controllers, power sources etc.

4B: Focused X-Wave Based Printers

Referring to FIGS. 43 and 44 there are depicted perspective and cross-sectional views respectively of a 3D AM printer using a FES according to an embodiment of the invention. The 3D AM printer consists of five major components, the Focused Energy Source (FES), a casing, a printing tank, a building platform, and the printing material. Considering these parts individually:

4B1: Focused Energy Source (FES)

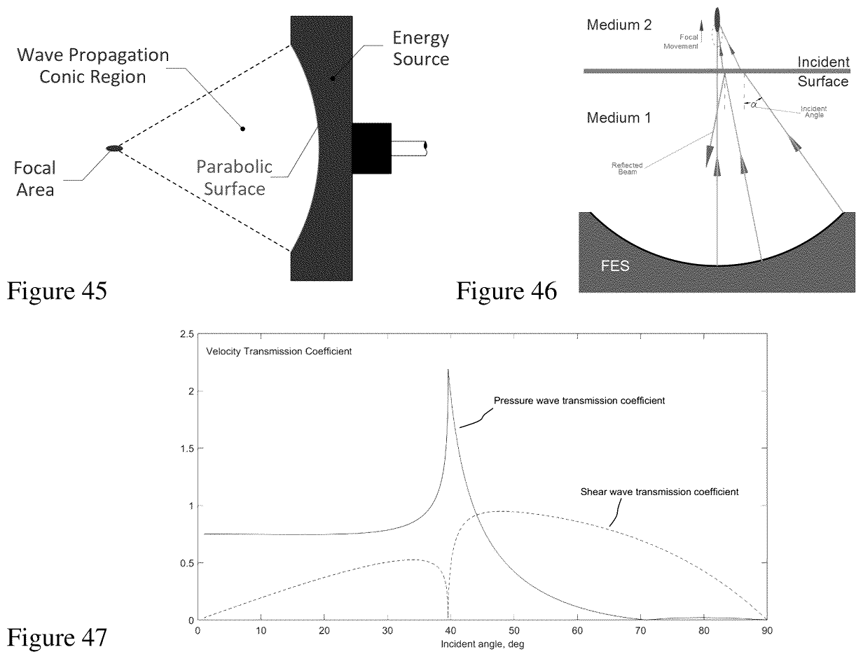

The FES as described above refers to an energy source with associated elements able to focus the generated X-waves at a specific point which is defined as the focal point or focal volume. A parabolic geometry of energy source's surface helps in generation of the focused energy as depicted in FIG. 45 with the schematic of an exemplary FES according to an embodiment of the invention. The focal region is formed by interfacing of multiple transmitted X-waves. This region could be in different shapes such as a point or a 2D oval or a 3D ellipsoid according to the specific geometry of the elements focusing the X-waves. Increasing the radius of curvature, for example, changes the focal shape from an oval to a point but also increases the size of the FES which can be important when seeking to employ multiple FES as the transmitting elements. Within embodiments of the invention the X-waves exploiting a FES such as depicted in FIG. 45 may be generated by a UV laser, an IR laser, an X-ray source, and/or an ultrasound transducer for example.

4B2: Casing

The casing provides a closed space to isolate the media of X-wave propagation from environment. The FES is embedded at the bottom of the casing and sealed. Depending upon the characteristic of generated X-waves this cavity could be under vacuumed or filled with a material either in the form of a solid, liquid or gas which has an excellent X-wave transmission characteristic to decrease the energy loss of the passing X-waves. Water and air examples for the X-wave propagation medium. The casing material could be chosen from variety of solid materials such as metals, plastics, and ceramics. The internal dimensions are determined such that no interference between the unwanted reflected X-waves from solid surfaces and the propagated X-waves from FES occurs, ideally. In case of necessity for minimizing the dimensions, the usage of proper isolation on internal bare surfaces should be taken into account. Normally, these type of isolations are being used in the presence of the acoustical X-waves.

4B3: Printing Tank

The printing tank is the reservoir space for the printing material which is loaded into the 3D AM printer. This tank may include an insert in FIG. 44) at the center which is transparent to the X-waves whilst the remainder of the body of the printing tank may be opaque or have high attenuation with respect to the X-waves. The transmission of X-waves through this insert depends on the incident angle of the X-wave beam with the surface of the insert. In fact, by deviation of the X-wave beam incident angle from 90°, the reflection and refraction will happen to the X-wave beam, as shown in FIG. 46. This causes the reduction in X-wave transmission power as well as deformation and movement of the focal point or focal volume.

4B3.1: Optimizing the Geometry of the Cavity

Considering ultrasonic pressure X-waves then these are transmitted from water (which forms the wave transmission medium within the chamber surrounding the FES through the insert in the printing tank, depicted as spherically shaped in FIG. 44. The spherical shape is the optimum design to minimize energy loss and shear X-wave wherein this geometry optimization problem is explained below. For ultrasonic waves then the transmitted X-wave in the cavity is divided into the pressure X-waves and shear X-waves. The pressure and shear transmission X-wave coefficients versus incident angle are plotted in FIG. 47 for the case of polystyrene as the interface and water as the transmitting medium. As shown in FIG. 47, pressure X-wave transmission coefficient remains constant below ˜30° angle of incidence whereas the shear X-wave coefficient increases linearly approximately in the range 0-30°. Accordingly, above 30° increasing pulse distortion. Accordingly, from FIG. 47 the optimum incident angle is 0° where shear transmission coefficient is zero.

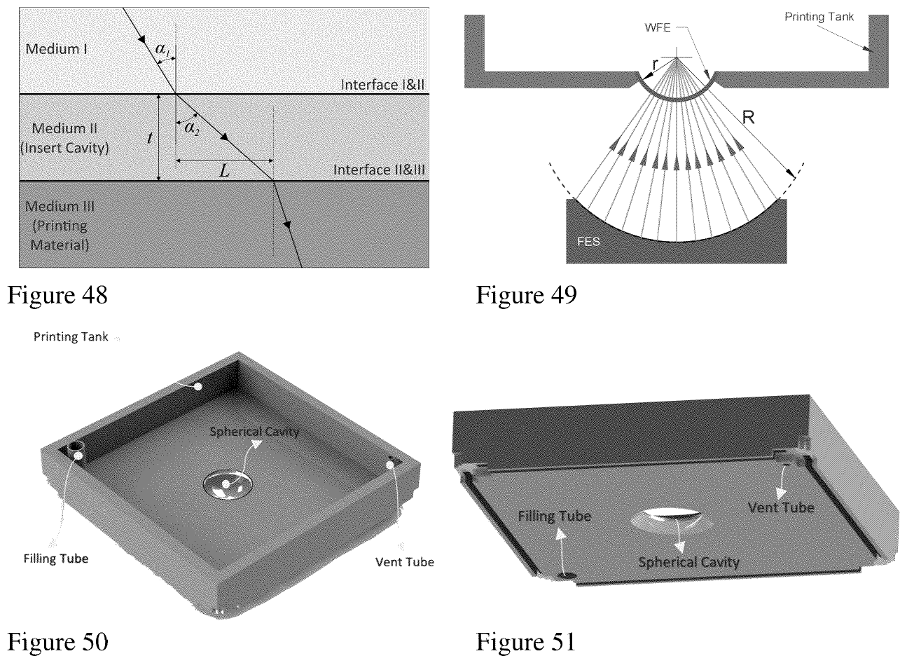

Now referring to FIG. 48 the X-wave is depicted being transmitted from Medium I (e.g. wave transmitting medium) to Medium II (e.g. insert of printing tank) and then to Medium III (e.g. build material). Based on Snell's law transmitting angle, α₂, can be written as Equation (1) where α₁, c₁ and c₂ are incident angle, sound velocity in Medium I and sound velocity in Medium II receptively. Accordingly, as the insert in the printing tank shell has a specific thickness, t, then location where the transmitting X-wave contacts the interface between Medium II and Medium III can be defined by distance, L, where L is determined by Equation (2).

α₂=sin⁻¹((c₂/c₁)sin(α₁)) (1)

L=(t·c₂·sin(α₁))/(c₁·\sqrt{1−c₂²·sin(α₁)²/c₁²}) (2)

1−c₂²·sin(α₁)²/c₁²=0 (3)

α₁*=sin⁻¹(c₁/c₂) (4)

Accordingly, L tends to infinity when the condition given by Equation (3) is satisfied. Therefore, critical incident angle, α₁*, can be derived by Equation (4). Accordingly, the incident angle of the transmitting X-waves should not exceed α₁*, therefore, 0≤α₁≤α₁*. For the case of polystyrene forming the insert cavity α₁*=39.41°. Equation (2) is independent oft, the thickness of the insert cavity shell. However, for the small thickness, Equation (1) should be considered too because due to the small t, L might be large enough to cause undesired interference of the X-waves inside the cavity shell.

As a result of analysis on the incident angle (FIG. 48 and Equation (2)), the optimum incident angle (α₁**) to avid loss of energy and undesired interference of the X-wave is zero (a₁**=0). To apply α₁**=0 a spherical cavity insert was designed and located at the center of the focused energy source. As a result, from now on the Insert/Spherical cavity will be called Wave Front Enhancer (WFE). As it was mentioned, the FES and WFE are installed at the same center, as shown in FIG. 49. Therefore, the transmitted X-waves will pass through the WFE and propagate into the printing material without angle change. In order to form the focal region inside the printing tank, a bit above the floor level, the height of WFE has to be less than the radius of corresponding sphere. This location of focal region prevents erosion of the printed layer by the tank's floor. FIGS. 50 and 51 depict perspective views of the printing tank for exemplary FES based 3D AM printer according to an embodiment of the invention.

Typically, the size of the printing tank is defined by the size of largest 3D printed object. Usually it is considered to be 1.5 times larger than the maximum dimension of the object projected in the horizontal plane. However, depending upon the application the printing tank and casing could be in different sizes. The printing tank could be fabricated from solid materials such as hard plastic(s), ceramic(s), or metal(s). The WFE is normally made from the plastic materials which possess proper characteristic against the X-wave transmission although for some X-waves other materials such as ceramics and/or composites may be appropriate. Furthermore, the filling tubes, which were shown in FIG. 50 are utilized for filling the casing with liquid and performing the venting of trapped air.

4B4: Building Platform

As it was shown in FIG. 43 the 3D object will be fabricated on a building platform layer by layer. The first layer will stick to the surface of the platform and next layers to previous one subsequently. This platform could be made from solid materials such as metal(s), ceramic(s) or plastic(s) which show a good adhesion property against the first cured layer of the printing material at the beginning of AM process. The building platform can be manipulated either manually, by employing a CNC tool or a robot arm for example. The manipulator moves based on the imported CAD derived files, e.g. a stereolithography file (STL) which includes the CAD information of the whole 3D object.

4B5: Printing Material

Essentially all liquid polymers which are solidified by applying the heat energy could be utilized for fabrication of 3D objects by implementing this innovative 3D AM printer. In addition, printing materials should possess the low transmission impedance against the propagated X-waves in order to minimize the energy loss during the process.

4C: Vertical Acoustic 3D Printer Prototype

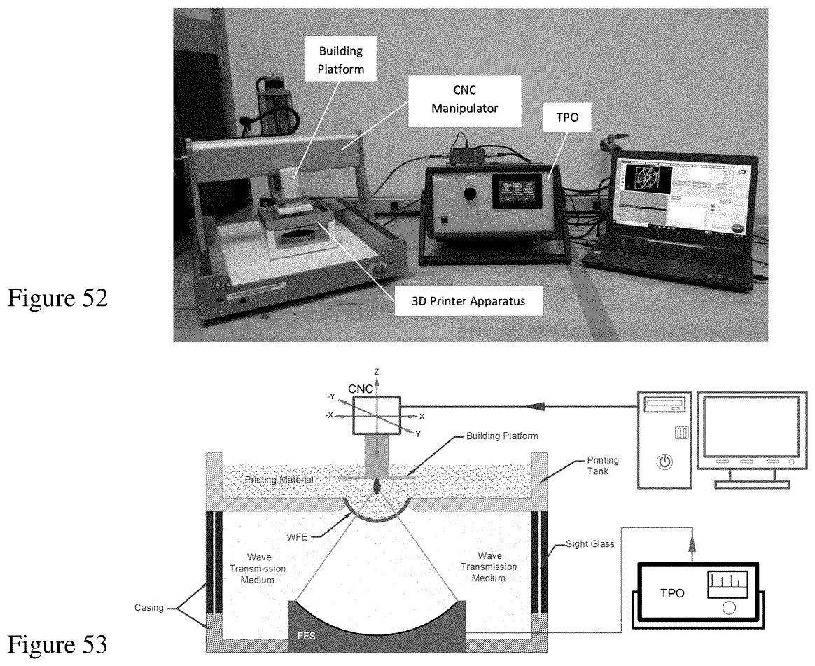

In order to study and prove the design concept of the vertical acoustic 3D AM printer according to embodiments of the invention the inventors implemented a prototype as depicted in FIGS. 52 and 53 where an optical micrograph and schematic respectively of a prototype FES based 3D AM printer according to an embodiment of the invention. As with the prototype described above in respect of Section 3 a high intensity focused ultrasound (HIFU) piezoceramic transducer was used as a FES. The HIFU transducer has a spherical front surface in order to focus the ultrasound X-waves at a focal point. As the HIFU transducers was originally designed and fabricated for biomedical applications the wave transmission medium was water. The characteristics of the HIFU transducer utilized in this experiment are shown in Table 3.

TABLE 3
HIFU Transducer Characteristics

| | Focal | Focal | Aperture | Maximum | |
|---|---|---|---|---|---|
| Frequency | Length | Region | Diameter | Input Power | Efficiency |
| (MHz) | (mm) | (mm) | (mm) | (W) | (%) |
| 2.5 | 50 | 2.29 × 0.43 | 72 | 180 | 85 |

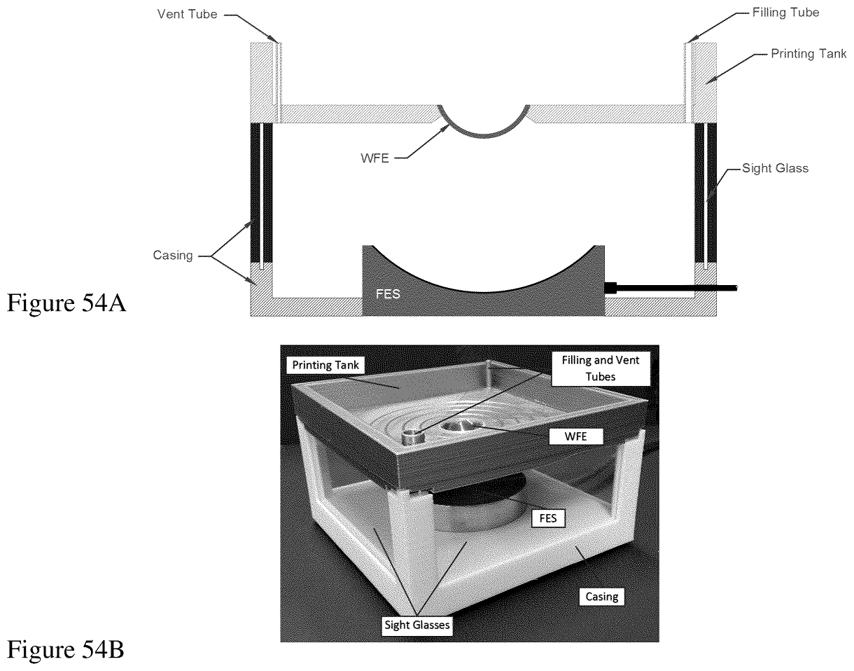

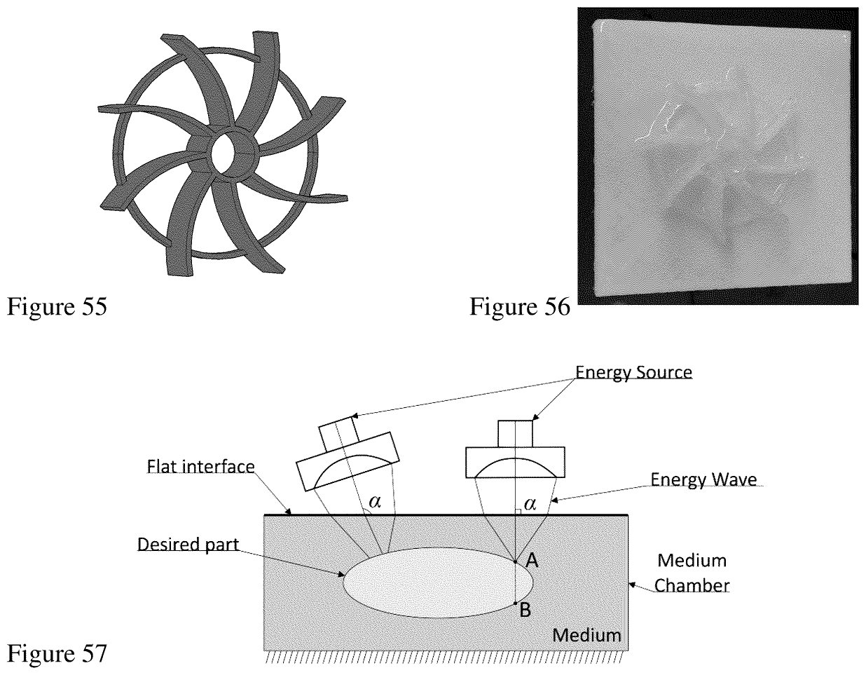

FIGS. 54A and 54B depict a schematic and optical micrograph respectively of the FES and printing tank for a prototype FES based 3D AM printer according to an embodiment of the invention. The casing and printing tank were fabricated from polylactic acid (PLA) material which combines benefits of light weight and an acceptable mechanical strength. Four sight glasses, made from transparent acrylic sheets, were assembled as a part of casing in order to provide a good vision on internal space and transducer during the process. The casing was filled with the degassed water. The WFE had the diameter of 3 mm and was fabricated from acrylic material. The building platform was made from acrylonitrile butadiene styrene (ABS, a thermoplastic polymer) and mounted on a Computer Numerical Control (CNC) machine which manipulated the platform in 3 directions in Cartesian coordinate system (X, Y, Z). Polydimethylsiloxane (PDMS) was utilized as the liquid polymer in this experiment and the device was being run for printing the designed object which depicted in FIG. 55 with a CAD model of the target 3D printed object.

The HIFU transducer was run at 2.5 MHz with 180 W supplied power. For printing the first layer building platform was submerged into the liquid resin and moved in XY plane by the CNC based on the designed pattern. This process was repeated for all layers until fabricating the whole 3D object. FIG. 56 depicts an optical micrograph of a fabricated 3D printed object using the CAD model of FIG. 55 with the exemplary prototype FES based 3D AM printer according to an embodiment of the invention depicted in FIG. 52. The AM process only took 14 minutes which a low printing duration in comparison with other 3D Printing technologies. As an example, the printing duration of this object by using a commercial Formlabs SLA 3D printer (Form 2) was takes 3 hours and 50 minutes (230 minutes or over 16 times longer).

4D: Robosono Printer Configurations

The position and orientation of the energy source with respect to the entering interface to the medium plays a crucial role in X-wave focusing as well as accessibility to different locations of the desired geometry. As shown in FIG. 57, if α=90°, the energy X-waves transmitted from the energy source can be focused at point A of the desired geometry. In this case, despite reflection and refraction of the energy X-waves, focal region is created at point A. However, if α=90°, X-waves can access point B to print at this location. In order to access to this point, the energy source could be inclined with respect to flat interface. However, if α≠90°, due to asymmetric refraction and reflection of the transmitted energy X-waves, a focal region is not formed. Therefore, versatility to access to different location of the desired geometry is limited if the energy source cannot be inclined with respect to the interface.

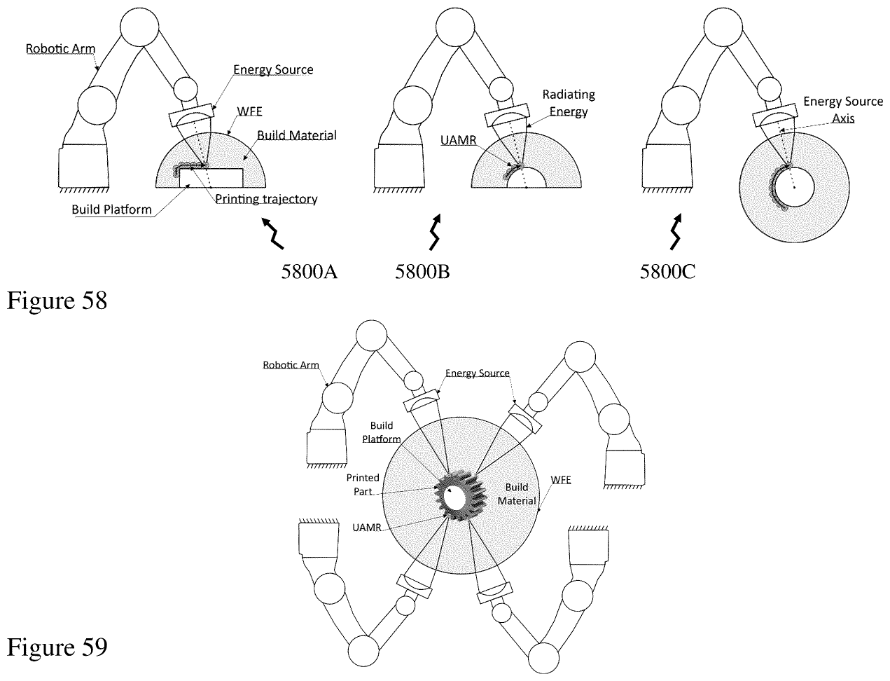

Accordingly, in order to solve this problem other embodiments of the invention the UAMR cluster is selectively created in the WFE. The energy source is moved around the WFE via a position manipulator that can provide at least six degree of freedom motion. This manipulator could be a Computer Numerical Controlled (CNC) machine or, as shown in FIG. 58, a robotic arm wherein schematically the system prints upon a flat platform in first image 5800A, a semi-spherical platform in second image 5800B and a spherical platform in third image 5800C. Using a robotic arm could be more effective in terms of the space occupation of the manipulator around the WFE. The manipulator (robotic arm in FIGS. 58 and 59) moves the energy source along the computer derived trajectory. Energy radiations passes through the shell of the WFE and after refraction (due to Snell's law for X-wave propagation for incident X-waves), all the energy rays transmitting from the energy source would be focused on a location on a platform. The motion of the energy source around the WFE makes the focus point to be moved on the platform and created UAMR region wherever the focal is selectively created. The speed of the UMAR trajectory can be defined as a constant or varying values however the position, orientation and velocity of the energy source will be calculated by the revere kinematic calculations. The manipulator located and orient the energy source continuously to create the controlled motion of the UAMR cluster in the WFE.

Forward kinematics of the mechanism shown in first image 5800A in FIG. 58A from the last joint of the robot connected to the energy source to the location of the UAMR where printing is happening is straightforward. However, what is needed is to find the corresponding joint locations and orientations (robot state) to get the required UAMR location in the WFE. To find the proper robot state, the constructed inverse kinematic is heavily non-linear and cannot be described by a closed form equation due to refraction of the X-waves while passing through the spherical boundary of the WFE. In first image 5800A in FIG. 58A, if the linear motion from point A to B with constant velocity is required, the robotic arm should exhibit nonlinear motion with varying velocity and acceleration to keep the velocity and location of the UAMR as required.

The platform shape does not play an important role in AM process as long as the energy source access passes through the center of the WFE. However, the shape of the platform can define the required support structures during the AM process. Based on the application and geometry of the desired part a proper platform shape can be selected.

In another embodiment of the invention, multiple manipulators and energy sources are used to print complex geometries as schematically shown in FIG. 59. The desired part geometry is divided into segments assigned to each manipulator/energy source for printing the part. In this embodiment, the part is printed on a platform. However, if two energy source are focused at the same location in such a way that the build material is trapped, there would be no need for the printing platform at the beginning of the AM process. The energy source could be in form of monolithic actuator, metamaterial, or hologram of variety of X-waves such as ultrasound, UV laser, X-ray or infrared.

4E: Robosono Printer Case Study

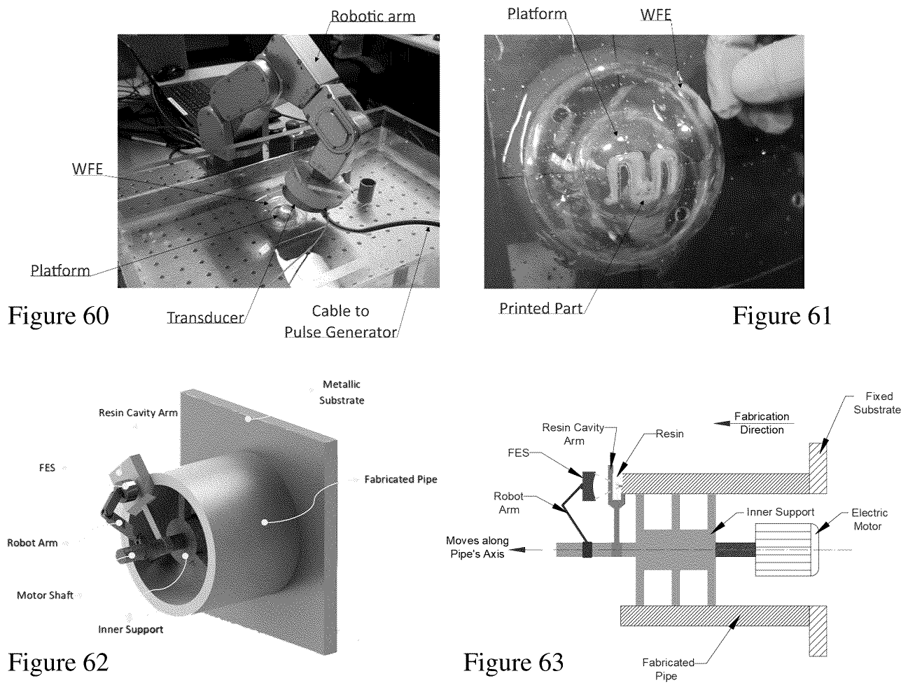

In this case study, a prototype apparatus is created as shown in FIG. 60. A six degree of freedom robotic arm manipulates the energy source (in this case a monolithic transducer) around the WFE. The part is printed on the platform while the robot is moving the transducer. The motion codes are generated and fed to the robotic arm by a computer. FIG. 61 shows the printed part in the WFE on the build platform.

4F: Continuous Hollow Object Printer

In the fabrication of plastic piping systems the mechanical strength of non-welded connections such as flanged/screwed joints, leakage at joints, the fabrication non-uniformity in pipe thickness as well as fabrication and assembling of the piping supports are critical parameters which should be taken into account in a design stage prior to the construction of piping systems. Increasing the thickness of pipes and fittings, installation of special supports as well as designing the special structures, bridges, or pipe racks in order to support the piping system are the common solutions to these problems and are associate with the cost impacts on the project. In order to overcome these deficiencies, using the integrated fabrication method in construction of piping system to minimize the discontinuities along the piping route would be the effective solution.

Accordingly, the inventors have considered an extension to the Robosono Printer concept described and depicted above in respect of FIGS. 58 to 60 respectively targeted at the fabrication of an integrated piping system having the capability of adaptation to the desired pipe route is introduced together with the ability to fabricate more complex pipe geometries with respect to wall structures etc. Accordingly, FIGS. 62 to 64 depict perspective, cross-sectional and end elevation views respectively of robotic a FES based 3D AM printer according to an embodiment of the invention to form a hollow structure such as a pipe and consists of four main parts, an inner support, a resin cavity arm, a robot arm and a Focused Energy Source (FES) such as described and depicted above with respect to embodiments of the invention. Whilst the following description is presented with respect to a circular pipe it would be evident that the methods and processes may be applied to other geometries and other applications without departing from the scope of the invention.

4F1: Inner Support

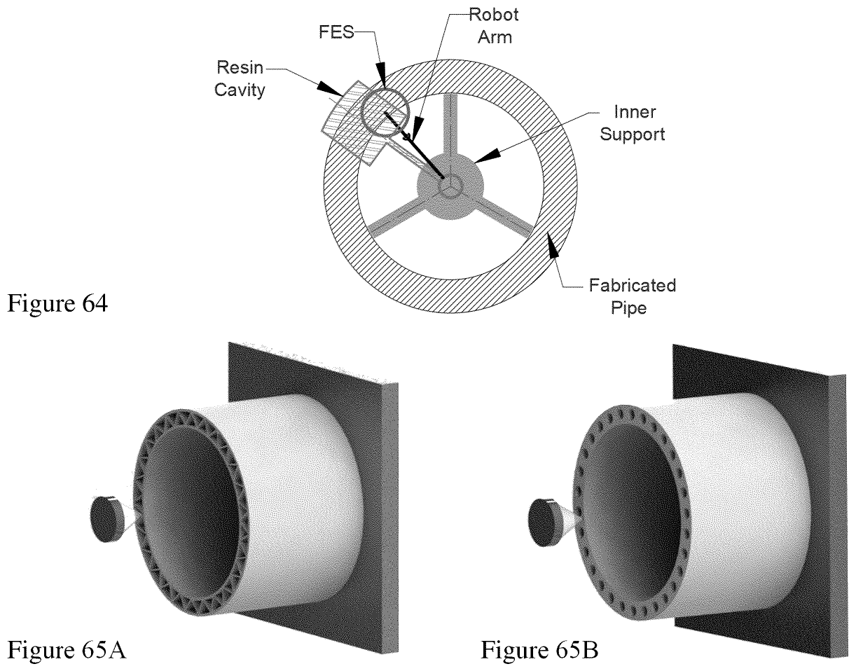

In order to prevent the distortion of a new fabricated pipe during an AM process an inner support is positioned co-axially inside the pipe, for example a metal support. The inner support's cross section is shown in FIGS. 63 and 64. The axes of the inner support and electric motor's shaft are co-axial. The electric motor provides the rotational motion of the other printing system parts which will be discussed in subsequent sections. The inner supports movement is limited to a linear motion along the pipe axis. For building a new layer, the inner support will be moved horizontally by an external manipulator in order to provide the required gap between the cavity and the last printed layer.

4F2: Resin Cavity Arm

This component includes 2 parts, an arm, and a cavity. The arm is connected to the inner support and can rotate about the inner support's axis plus expands along its axis in order to provide the possibility of printing of objects with non-symmetrical cross sections. The rotational movement is provided by the electric motor. The cavity is a part, filled with liquid resin. By rotation of the arm, cavity will supply the required resin for printing. In order to reduce the energy loss, the cavity would be fabricated from a material or materials having the low absorption for the transmission of X-waves through the cavity's wall.

4F3: Robot Arm

The robot arm carries the FES and is connected to the electric motor's shaft. In addition to the rotational motion provided by rotation of the rotor, the robot arm can move freely in all directions in a space in order to cover entire cavity's backing wall. The generated X-waves transmit through the cavity's backing wall into the resin and solidify it on the desired spot. Accordingly, the fabrication of each layer will be complete during full rotation of the rotary parts, namely resin cavity arm and robot arm.

4F4: Exemplary Pipe Structures

In addition to fabrication of the pipe with a complete wall such as depicted in FIG. 62 the continuous hollow object printer according to an embodiment of the invention may be employed to form more complex structures. FIGS. 65A and 65B respectively depict schematics of a corrugated wall pipe and pipe with longitudinal holes which can be fabricated using the robotic FES based 3D AM printer according to an embodiment of the invention depicted in FIGS. 62 to 64, respectively. It would be evident that flexibility in changing the position of the FES helps to build these complex geometries. The pipes with embedded hollow spaces in walls have a light weight and high mechanical strength compared to the other common solid wall pipes. Alternatively, a structure such as depicted in FIG. 65B allows for cables to be deployed through the length of the pipe or portions of the pipe length whilst a fluid is transported through the central bore. Optionally, the central bore can be sub-divided with the interior walls being continuously formed with the remainder of the pipe in a single seamless manufacturing process. It would also be evident that other elements such as access points, screw fittings to access points etc. could also be seamlessly formed during the formation of the pipe. These characteristics make these type of pipes suitable choice for the processes in which the pipes experience the high temperature gradient or external mechanical stresses.

5: Manufacturing Porous Objects with Wave Based Additive Manufacturing Processes Exploiting Ultra Active Micro-Reactors (UCON-255)

Porous structures are mainly created by gas-assisted injection molding, incorporating a foaming agent, porogen addition, and prior art Additive Manufacturing. In gas-assisted method, a liquid thermoplastic resin is injected into a mold where a pressurized gas is applied into the mold cavity. The gas creates hollow regions and pores whilst the thermoplastic cools down and solidifies. This process requires a mold which expensive and the obtained porosity is not uniform. With the addition of a foaming agent, gas is generated inside the liquid resin while the resin is solidifying due to UV or heat exposure. The requires relatively long solidification time and also there is limited control on the porosity range of the process. In porogen mixing method, typically wax, sugar or salt is mixed with the resin matrix which is then cured. The trapped solid porogens are dissolved in a solvent and final matrix has pores in the size of the porogen particles. This process is time consuming and there is limited control over interconnect or disconnect pore structure. In all the methods explained so far, a mold is needed to create a part with a complex geometry. Further manufacturing a single piece part with different porosities in different regions requires making several piece parts and then joining them together.

With Additive Manufacturing (AM) for polymers a porous object with a complex geometry can be created without a mold. However, within the prior art the geometry of the pores is included in the CAD model of the desired object to be printed. CAD model is sliced into many cross sections and each cross section contains the geometry of the pores for that section. AM creates the part cross section upon cross section until the part geometry is complete. AM processes are generally based on layer-by-layer concept. These prior art AM processes are time consuming due to layer-by-layer nature of the process wherein each pore is created one by one which makes the processing time longer and the minimum pore dimensions are determined by the characteristics of the AM process. As discussed above these prior art processes are HAZ+ processes such that lateral dimensions are large, and the pore “thickness” is defined by the layer-by-layer AM process characteristics.

Accordingly, it would be beneficial to provide a moldless AM process able to:
create complex porous structures with a very short solidification time (fraction of second);
provide a high degree of control on the size and distribution of the pores in the structure; and
support a monolithic piece part with multiple pore sizes/distributions; and
provide for both interconnected and disconnected porous structures with controlled pore size.

In common with preceding embodiments of the invention X-waves are employed to trigger UAMRs within regions of the part during manufacturing. Whilst in contrast to other embodiments of the invention the UAMRs are created in any liquid triggering solidification of the building material within these embodiments the UAMRs undergo growth, oscillation, and collapse within the build material. By exploiting chemically active UAMRs which cause the surrounding medium to undergo phase transition through polymerization the UAMR itself “explodes” thereby creating inactive micro-voids. These micro-voids themselves undergo inward collapse (radius reduction) due to pressure from the surrounding medium. The final radius of these micro-voids therefore defines the pore size of the material.

Beneficially embodiments of the invention provide for a wide range of applications for manufacturing porous materials such as foams, sponges, and lattice structures for making shims, insulators and scaffolds in construction, aerospace, automobile, and bioengineering industries.

5A: Conceptual Overview

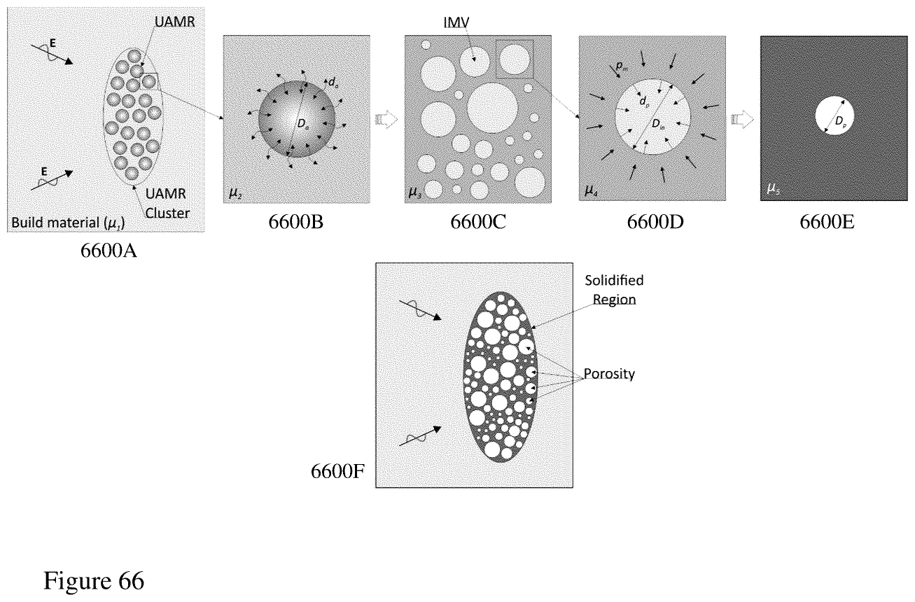

The general concept of embodiments of the invention is depicted schematically in FIG. 66 in first to sixth image 6600A to 6600F, respectively. In common with other embodiments of the invention X-waves from the energy source(s) interfere and create interference patterns in the build material as depicted in first image 6600A. When the energy of the constructive interference is sufficient it triggers the UAMRs within regions of the building material. Accordingly, within a UAMR region multiple UAMRs are created in clusters resulting in a highly chemically active region. Second image 6600B depicts an isolated UAMR. The UAMR vibrates and its diameter, D_{A}(t), oscillates. The UAMR is chemically active and in common with preceding UAMRs the localized pressure and temperature inside and on the shell of UAMR are very high such that the build material within the immediate vicinity of the UAMR starts to solidify and changes its properties. For example, viscosity of the build material changes from μ₁ to μ₂ (μ₁<μ₂). When the UAMR diameter reaches a critical value, D_{A}, the UAMR explodes and creates many chemically inactive micro voids (IMV) as shown in third image 6600C in FIG. 66. Due to the ongoing solidification in the viscosity of the explosion, μ₂<μ₃. Fourth image 6600D is a magnified image of a single produced IMV. With ongoing solidification of the material in the vicinity of the IMV this creates an inward pressure, P_{M}, on the exterior shell of the IMV as shown in fourth image 6600D. Due to this external pressure, the shell of the IMV experiences an inward collapse wherein the shell diameter, D_{IN}, would have inward collapse velocity, depicted as d_{P}(t), such that the final IMV diameter is reduced to D_{P} as depicted in fifth image 6600E in FIG. 66. The result depicted in sixth image 6600F is a solidified region which is filled will IMVs such that the solidified region is porous.

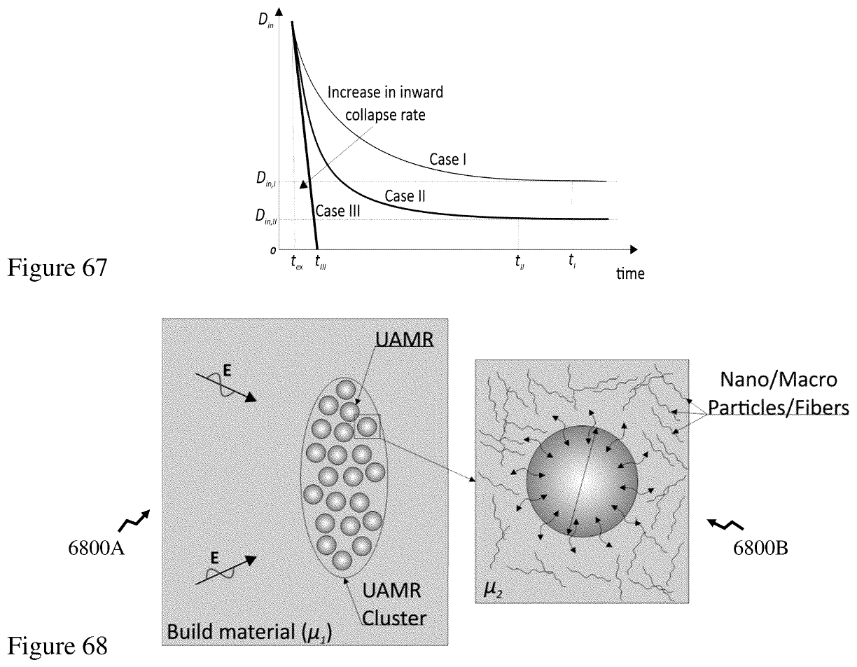

Now referring to FIG. 67 there are depicted three scenarios of forming IMVs within a 3D printed material exploiting UAMRs according to embodiments of the invention which can be considered based upon the behaviour of d_{P}(t) for defining the final diameter of the IMV, D_{IN}, where the surrounding medium is fully solidified and there is no inward collapse, d_{P}=0.

In case I, the surrounding medium causes the IMV to collapse but the velocity of the collapse is not enough to close the IMV, i.e. to result in D_{IN}=0. Accordingly, D_{IN} reduces until t_{I} after which the IMV remains inside the just solidified vicinity as shown in FIG. 67 with a final diameter of D_{IN,I}.

In case II, D_{P} is larger than the case I and the final diameter of the IMV would be D_{IN,II}, where D_{IN,II}<D_{IN}, I.

If D_{P} is so large that during solidification of the medium, D_{IN,III} reaches zero then case III would occur and the IMV collapses completely.

Accordingly, it would be evident that cases I and II result in a porous structure while case III results in non-porous object. Accordingly, parameters affecting the solidification and IMV behaviour in order to reach either of these cases would include, but not be limited to, medium temperature, external pressure, vapor pressure, frequency, power, and signal type of the energy X-waves. The desired porosity sizes, D_{P}, can be varied further by tuning these parameters.

Within embodiments of the invention the building material could be liquid resin or composite resin as depicted in FIG. 68 as macroscopic image 6800A and microscopic image 6800B. Accordingly, within microscopic image 6800B it is evident that the build material incorporated additional components comprising one or more of nanoparticles, micro-particles, nanotubes, nanofibers, and microfibers so that these are also distributed within the porous final component.

5B: Energy Sources

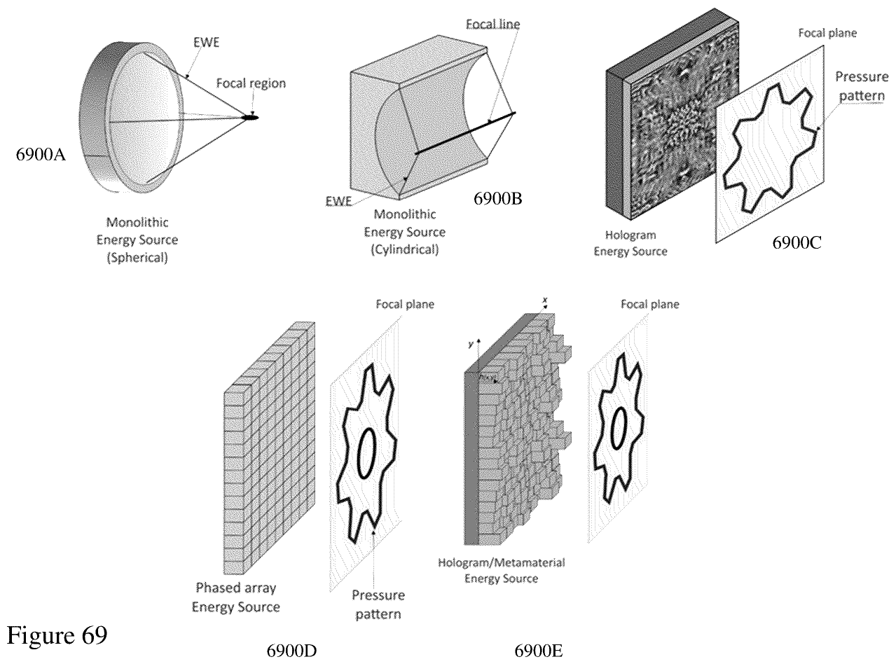

The X-waves in embodiments of the invention triggering the UAMRs within the UAMR regions of the build material could be transmitted from a variety of energy sources including, but not limited to, those depicted in FIG. 69 with first to fifth sources 6900A to 6900E, respectively. These may be employed interchangeably or in combination of one another according to the requirements of the X-wave AM process, system, build material etc. First and second sources 6900A and 6900B represent monolithic energy sources with spherical and cylindrical transmitting surfaces, respectively wherein the majority of the X-waves are transmitted in the energy X-wave envelope volume, EWE, and focused at the focal region. Third source 6900C depicts a holographic energy source with a monolithic or discrete passive hologram in combination with a transducer to create a pattern in the focal plane. Fourth source 6900D depicts an array of small energy sources to create a desired pattern on the focal plane by exploiting phased array concepts. Fifth energy source 6900E depicts an active hologram source exploiting dynamically adjustable elements, e.g. height, in order to create the target energy pattern at the focal plane. With each energy source of first to fifth energy sources 6900A to 6900E respectively the UAMRs triggered within UAMR clusters or UAMR regions at the regions where the energy from the energy source is focused thereby triggering the fast material phase transitions as described within the specification.

5C: Exemplary Porous Material Additive Manufacturing Methodologies

5C1: Solid Porous Panel

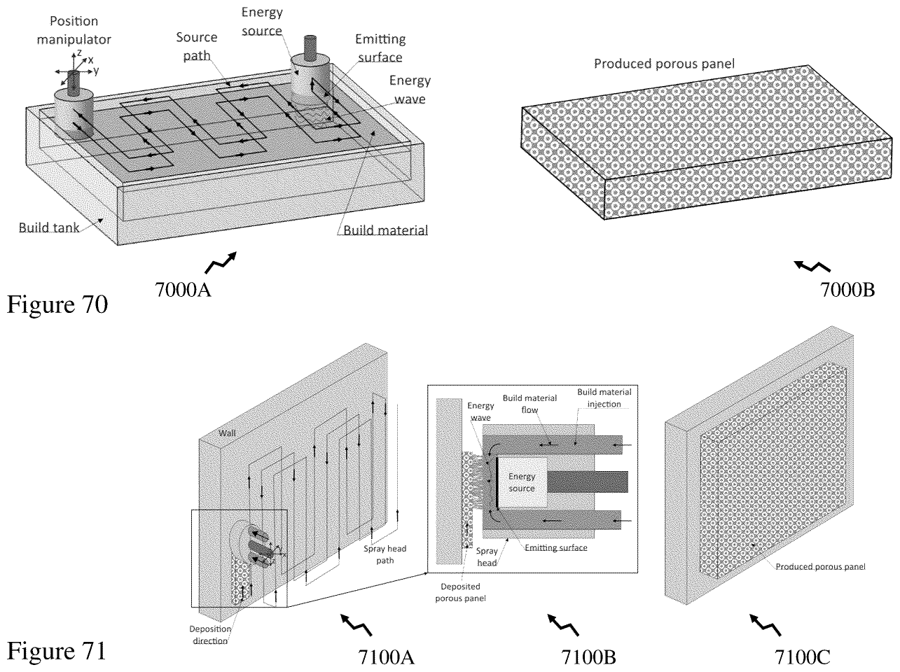

In this embodiment of the invention, a composite liquid is poured into a build tank as shown schematically in first image 7000A in FIG. 70. Then the energy source is moved by a positional manipulator in the build tank. Due to the focused X-waves, the build material undergoes phase transmission underneath of the energy source as the UAMRs are triggered within the trajectory of the UAMR region generated by the focused X-waves. Accordingly, first image 7000A depicts a source path which consist of two different height (z) levels relative to the build tank. In the first z level, a first layer of the porous panel, shown in second image 7000B in FIG. 70 is created and in the next z level another layer is built up upon the first layer. The result is a panel with controlled porosity. The number of levels and also complexity of the path depends on the final geometry of the porous part, the characteristics of the build material, the beam geometry/volume of the energy source etc. The motion parameters such as velocity and acceleration of the energy source depends on the porosity size and type (interconnected or disconnected pores) of the produced part together with energy of the energy source, energy required to trigger the UAMRs etc.

Accordingly, employing different energy sources shown in FIG. 69 could lead to implementing different AM manufacturing systems targeted to different products/structures/porosity etc. For example, using the single focus source (such as first source 6900A in FIG. 69) could lend itself to produced parts requiring precise dimensions and/or very complex external geometries whilst using a line focused energy source (such as second source 6900B in FIG. 69) could lead to a more productive and efficient machine due its elongated focal region such as for forming slabs/sheets of porous material for example.

5C2: Foam Structure Spray

Within another embodiment of the present invention, a spray head is depositing a porous structure on platform (wall) as shown in first and second images 7100A and 7100B in FIG. 71. Accordingly, build material is injected through channels mounted in the spray head. For example, two channels are shown in first and second images 7100A and 7100B whilst it would be evident that the number of channels and/or their spatial relationship may be varied within other embodiments of the spray head according to embodiments of the invention. A positional manipulator, e.g. a user, a robotic arm, robotic system, android, moves the spay head along a path as shown in first image 7100A. While these motions are occurring, the build material is injected into the focal region of the energy field produced by the energy source thereby triggering the formation of the UAMR clusters. For example, considering an acoustic or ultrasonic energy source then the non-linear acoustic fields from the energy source are focused at a depth away from the front of the spray head projected into the build material. Optionally, an attachment forming part of the spray head defines the distance of the spray head from the object it is moving relative to, e.g. a wall, such that the focal region is a defined distance or distances with multiple settings/sweeps of the spray head.

As depicted in first image 7100A three z level motions are depicted, however, the complexity and number of the motions depends on the geometry of the required object. The final part is shown in third image 7100C where all required path is covered by the spray head. By employing spray heads according to embodiments of the invention then the material generated by the itself produces a porous material for the final structure wherein as described below in respect of other embodiments of the invention the level of porosity can be varied within the formed structure but it is evident that high porosity can be achieved within embodiments of the invention.

5C3: Porous Thin Films

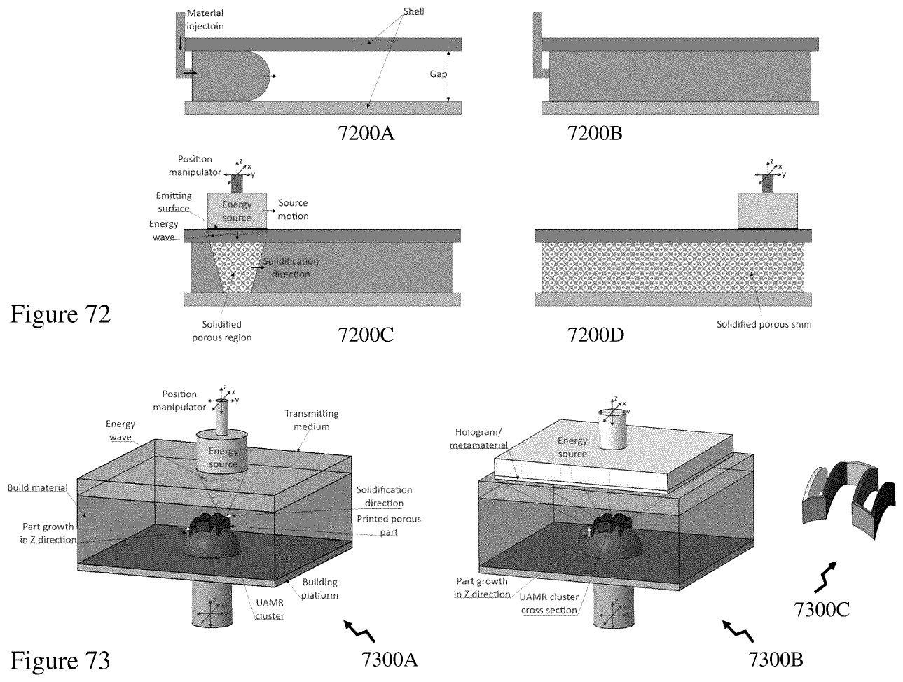

In another embodiment of the patent, manufacturing thin foam films such as shims are considered where two or more metallic or composite sheets create narrow gaps. FIG. 72 depicts schematically forming a porous shim within a structure using IMVs and UAMRs in association with a FES based 3D AM printer according to an embodiment of the invention. Accordingly, as depicted in first image 7200A a build material is injected between the sheets (shell) defining at least the upper and lower surfaces of the porous thin film until the region is filled as depicted in second image 7200B. Then as depicted in third image 7200C the energy source generating the X-waves is moved relative to the assembly wherein the X-waves pass through the shell and penetrate the build material and reach the opposite shell. In the EWE volume, the material begins to undergo phase transformation from liquid to solid due to creation of UAMRs with or without the formation of IMVs according to embodiments of the invention. Within embodiments of the invention the energy source may be moved relative to the shell or the shell can be moved relative to fixed energy source. The energy source has proper matching layer between the emitting surface and the shell to ensure proper transmission and minimize transmission loss. The energy source moves continually or intermittently to solidify the material in the gap as shown in third and fourth images 7200C and 7200D respectively in FIG. 72. This embodiment of the embodiments of the invention has wide range of applications in shimming in aerospace or automobile industries where insulations needs to be created in the gaps in bodies after assembly or for forming porous sheets for use in other applications such as construction etc.

5C4: Single Piece Part with Variable Porosity

Within embodiments of the invention complex part geometries can be formed in a single manufacturing sequence to yield a single piece part. However, within the prior art forming a single piece part with variable porosity cannot be achieved. However, the inventive processes established by the inventors exploiting UAMRs and IMVs allow simple or complex part geometries to be created with variable levels of porosity across the structure. FIG. 73 with first to third images 7300A to 7300C respective depicts schematically forming a 3D part with varying porosity upon a platform using either a monolithic FES or holographic/meta-material based FES in conjunction with IMVs and UAMRs according to an embodiment of the invention. Accordingly, referring to first image 7300A the piece part is generated using an energy source wherein UAMRs are generated within the build material to form the structure (part). However, as the energy source is positioned with respect to different parts of the structure then using the mechanisms described and depicted above with respect to the formation of IMVs in association with UAMRs adjustments in the process dynamically during manufacturing allow for the IMVs to be selectively established in different regions as Case I, Case II, or Case III. Accordingly, a region with porosity (e.g. Case I) can be established in the same manufacturing sequence as an adjacent region without porosity (e.g. Case III) from the same build material.

5C5: Complex Part Manufacturing without a Platform Via Multiple Energy Sources

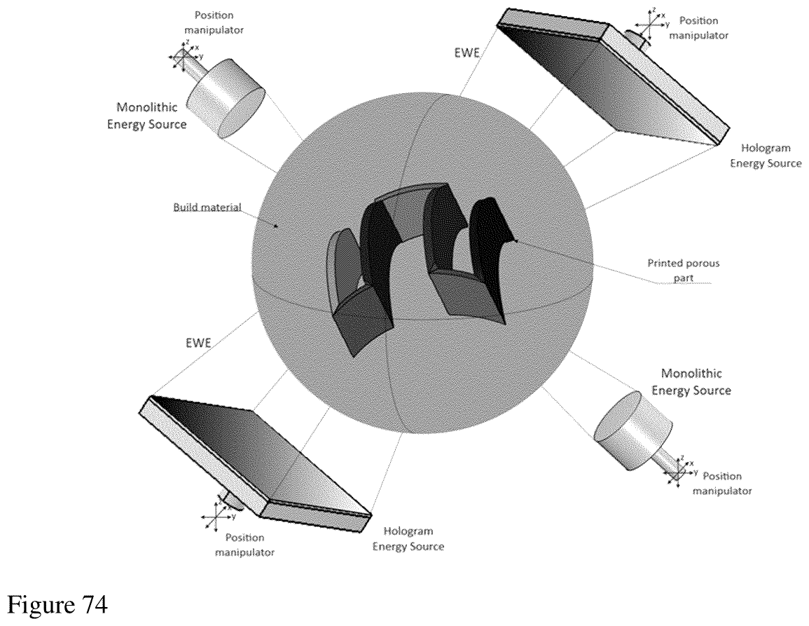

Within the embodiments described within Section 5 to this point all embodiments of the present invention have the structure created upon a platform or substrate. However, the part can be printed without a platform by interference of the X-waves form multiple energy sources as shown in FIG. 74. In FIG. 74 there is depicted depicts schematically forming a 3D part with varying porosity without a platform through wave interference using either a monolithic FES or holographic/meta-material based FES in conjunction with IMVs and UAMRs according to an embodiment of the invention. Accordingly, within embodiments of the invention a single form of X-waves may provide trapping and triggering through use of focused energy sources and/or holographic/metamaterial energy sources are located in such a way that the interference of the transmitting X-waves create the region in the form of the part geometry where UAMRs and consequently IMVs are created. Within other embodiments of the invention a first X-wave type may provide trapping whilst a second X-wave type may provide triggering. Within other embodiments of the invention a single X-wave type may be used but focused energy sources may be employed for triggering with holographic/metamaterial energy sources for trapping or vice-versa.

5D: Material and Pore Size

Manufactured structures according to embodiments of the invention may be produced, for example, using resins that can be polymerized by free radical polymerization, hydrosilylation or ionic mechanism reaction which require the opening of bonds like double-bond in vinyl terminated monomers or any phase transitions using high intensity heat and temperature created in UMARs. The build material may therefore include, but not be limited to, a pure resin, mixture of resins (different resin parts), solid powders (plastic, ceramic, glass, or metal powders) coated with resin or a slurry of solid powders in a resin matrix. The build material may alternatively be liquid resin mixed with biomass derived from one or more sources. Any monomer that is solidified by the free radical polymerization can be printed as the structural substance such as DMS, MMA, BA, vinyl acrylate and other monomers with a vinyl functional end group can be used. Nanoparticle synthesis of metal solutions such as Au, Ag, Pt, Fe, Ni, Pd and many other organometallics can be performed at the same time while polymerization of the matrix is performed. Multifunctional and composite parts can be printed. For example, adding carbon nano tubes (CNTs), metal nano particles and/or metal liquids to the polymer could make the printed object conductive and add physical and electrical multifunctionalities.

Beneficially the pore size and pore distribution can be regulated (manipulated/controlled) by changing the properties and pattern shapes of the X-waves applied to the structure in triggering the UAMRs and therein the IMVs by applying external pressure to the build material locally.

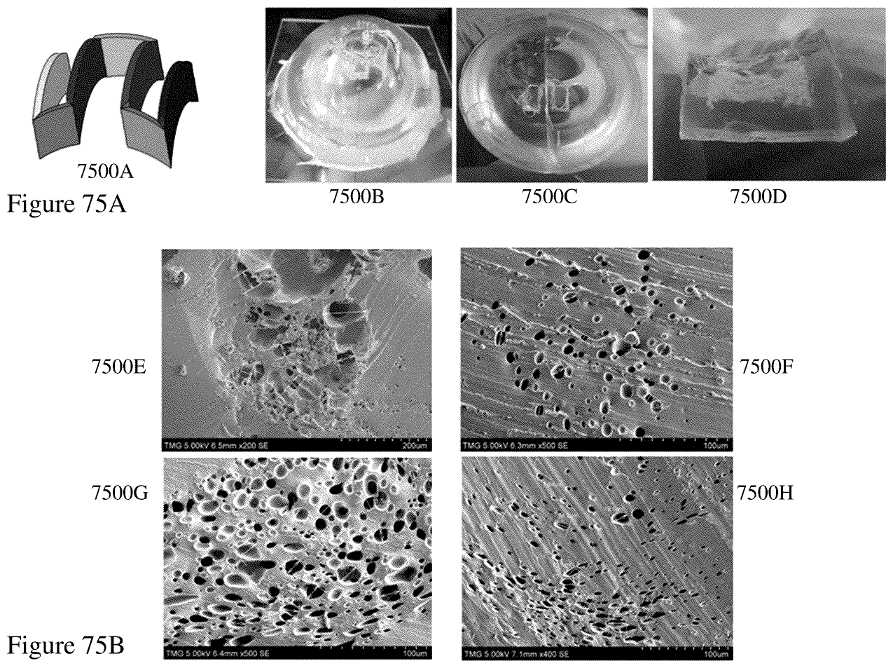

In order to demonstrate this using a prototype configuration configured as outlined in first image 7300A in FIG. 73 with a focused energy source was employed to create a piece part structured as depicted in first image 7500A in FIG. 75A. The part was created using PDMS as the build material in a spherical build chamber on a spherical build platform with ultrasound as the X-wave. Second to fourth images 7500B to 7500D depict different views of the printed porous part.

FIG. 75B depicts first to fourth scanning electron micrograph (SEM) images 7500E to 7500H respectively of different regions of the fabricated piece part showing the different levels of porosity achieved within different regions.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method of manufacturing a part, comprising:
providing a plurality of transmitting elements, each transmitting element of the plurality of transmitting elements generating a predetermined wave type directed into at least one of a build chamber and a medium chamber;
providing a build material within at least one of the build chamber and the medium chamber comprising at least one of a resin, a slurry, a colloidal solution and a powder comprising coated particles;
exciting a predetermined portion of the plurality of transmitting elements into predetermined states in order to generate a plurality of waves into the at least one of the build chamber and the medium chamber to generate a wave image; wherein
the wave image generates an energy density of the waves which trigger a plurality of micro-reactors within the build material thereby solidifying a portion of the build material within the wave image; and
the wave image relates to a predetermined portion of a part being manufactured.

2. The method according to claim 1, wherein
providing the plurality of transmitting elements comprises at least one of:
providing the plurality of transmitting elements as part of at least one of a build chamber and a medium chamber by at least one of:
attaching the plurality of transmitting elements to the at least one of the build chamber and the medium chamber such that they are disposed upon a surface of the at least one of the build chamber and the medium chamber;
attaching the plurality of transmitting elements to mounts such that the plurality of transmitting elements are disposed within the build material; and
providing the plurality of transmitting elements as floating elements within the build material; and
providing a phase changing element disposed in a predetermined relationship in front of each transmitting element where each phase changing element is selected from the group comprising a hologram storing an image, a hologram storing multiple images, a static metamaterial, a phased array of elements, and a metamaterial comprised of a plurality of dynamically configurable metamaterial elements; and
providing at least one of a planar source and a focused source as each transmitting element of the plurality of transmitting elements.

3-4. (canceled)

5. The method according to claim 1, wherein
at least one of:
the wave image is a two-dimensional image such that the plurality of micro-reactors are defined on a plane;
the wave image is a three-dimensional image such that the plurality of micro-reactors are defined within a volume.

6. The method according to claim 1, wherein
at least one of:
each micro-reactor of the plurality of micro-reactors exhibits at least one of a rate of heating and a rate of cooling on a time scale of nanoseconds;
each micro-reactor of the plurality of micro-reactors affects a region of the building material defined by a distance scale of nanometers; and
the build material local to each micro-reactor of the plurality of micro-reactors undergoes a phase transition to solid.

7. (canceled)

8. The method according to claim 1, wherein
at least one of:
the build material further comprises a resin which is polymerized and solidified by free radical polymerization where each micro-reactor of the plurality of microreactors triggers the free radical polymerization of the resin;
the build material further comprises a resin which is polymerized and solidified by at least one of heat and pressure generated by the plurality of micro-reactors;
the build material further comprises a powder comprising particles coated with a resin which is solidified by the plurality of micro-reactors to create a green part requiring subsequent thermal processing;
the build material further comprises a powder comprising particles coated with a resin which is solidified by the plurality of micro-reactors to create a green part requiring subsequent thermal processing to sinter the powder; and
the build material further comprises a powder of at least one of a ceramic, a metals and a glass dispersed in a resin matrix where the resin matrix is solidified by at least one of a chemical reaction and a physical reaction associated with the plurality of micro-reactors;
the build material further comprises a powder of particles dispersed in a resin matrix where the resin matrix is solidified by at least one of a chemical reaction and a physical reaction associated with the plurality of micro-reactors; and
the build material further comprises at least a powder coated with a resin which polymerizes via free radical polymerization and each micro-reactor of the plurality of microreactors triggers the free radical polymerization of the resin.

9. The method according to claim 1, wherein
the build material is a matrix further comprising a body material and one or more additives selected from carbon nanotubes, metallic nanoparticles, electrically conductive nanoparticles, rheological particles and magnetic nanoparticles; and
the predetermined portion of the part has at least one of a conductive portion and a magnetic portion.

10. The method according to claim 1, wherein
a porosity of the material generated as a result of the excitation of the plurality of micro-reactors is controllable; and
at least one of a size of the pores and a distribution density of the pores is controllable in dependence upon at least one of a frequency and a power of the plurality of waves.

11-18. (canceled)

19. The method according to claim 1, further comprising
exciting another predetermined portion of the plurality of transmitting elements into predetermined states in order to generate a plurality of other waves into the at least one of the build chamber and the medium chamber to generate another wave image; wherein
the plurality of other waves apply
material post processing comprising at least a second processing step wherein at least one the predetermined portion of the part being manufactured and the part being manufactured is sintered.

20. (canceled)

21. The method according to claim 1, further comprising
providing a plurality of phase changing elements, each phase changing element disposed in a predetermined relationship in front of each transmitting element wherein at least one of:
during manufacturing of at least one the predetermined portion of the part being manufactured and the part being manufactured a subset of the plurality of phase changing elements are moved according to a predetermined profile continuously such that a three-dimensional multi-section extrusion is generated; and
during manufacturing of at least one the predetermined portion of the part being manufactured and the part being manufactured a subset of the plurality of phase changing elements are moved according to a predetermined profile relative to their associated transmitting elements so that a plurality of images associated with the phase changing elements are sequentially accessed such that a three-dimensional multi-section extrusion is generated with a series of cross-sections defined by the plurality of images; and
the plurality of phase changing elements are dynamically configurable in real time.

22-25. (canceled)

26. The method according to claim 1, wherein
each transmitting element of the plurality of transmitting element comprises a nozzle; and
nozzle comprises:
a focused energy source having a focal region; and
a material injection channel for delivering one or more materials of a plurality of materials to the focal region.

27-28. (canceled)

29. The method according to claim 26, wherein
the focused energy source is at least one of:
coupled to transmitting chamber disposed between the focused energy source and the one of the build chamber and the medium chamber where the transmitting chamber moves with the focused energy source when the focused energy source is moved;
a monolithic energy source;
a phased array of energy sources;
one or more energy sources with at least one of a static and a dynamic hologram disposed between the one or more energy sources and the focal region; and
one or more energy sources with at least one of a static and a dynamic metamaterial disposed between the one or more energy sources and the focal region; and
the focal region is at least one of static and dynamically configurable.

30. (canceled)

31. The method according to claim 26, wherein
the nozzle further comprises:
a casing disposed around a region with the focused energy source at a first end of the casing;
a window transparent to waves generated by the focused energy source disposed at a second distal end of the casing; and
a fluid filling the casing supporting transmission of the waves generated by the focused energy source.

32. The method according to claim 31, wherein
at least one of:
the material injection channel is axially aligned with the casing and passes through window at the second end;
the material injection channel is external to the casing and disposes the one or more materials adjacent to the window; and
the window has a geometry which is at least one of planar, convex, concave and free-form established in dependence upon at least one of the configuration of the focused energy source and the waves generated by the focused energy source; and
the material injection channel is axially aligned with the casing and passes through the first end and the second end.

33-35. (canceled)

36. The method according to claim 26, wherein
the nozzle is one of a plurality of nozzles forming part of a printing head for an additive manufacturing process;
each nozzle of the plurality of nozzles employs at least one of the same one or more materials and different one or more materials; and
at least one of:
the printing head as a planar geometry with the plurality of nozzles disposed along the planar geometry;
the printing head has a non-planar geometry with the plurality of nozzles disposed along the non-planar geometry; and
the plurality of nozzles are disposed upon the print head in at least one of a one-dimensional array, a two-dimensional array, and a predetermined pattern.

37-41. (canceled)

42. The method according to claim 1, further comprising
a wave front enhancer disposed between the medium chamber and the build chamber;
the plurality of transmitting elements are coupled to the medium chamber;
the build material is disposed within the build chamber; and
the wave front enhancer acts to transition the waves from the medium chamber to the build chamber.

43. The method according to claim 1, further comprising
providing a plurality of positional manipulators, each positional manipulator of the plurality of positional manipulators having mounted upon it a predetermined subset of the plurality of transmitting elements; and
each positional manipulator of the plurality of positional manipulators is controlled by a microprocessor to execute a predetermined sequence of motion during manufacturing of the predetermined portion of the part.

44. The method according to claim 1, further comprising
providing a system comprising:
the plurality of transmitting elements:
providing a plurality of positional manipulators, each positional manipulator of the plurality of positional manipulators having mounted upon it either a predetermined subset of the plurality of energy source or the build chamber;
providing a frame to which the build chamber and the plurality of positional manipulators are attached; and
providing an electric motor attached to the frame; wherein
the system constructs the predetermined portion of a part being manufactured as a hollow structure as a single continuous element wherein the system moves along a predetermined trajectory as it constructs the hollow structure;
the motor provides for at least one of linear movement of the frame during manufacture of the predetermined part and rotation of the plurality of positional manipulators about an axis of the hollow structure; and
the frame is supported within the hollow structure.

45. The method according to claim 44, wherein
the hollow structure is a pipe; and
at least one of:
the system when manufacturing the hollow structure also generates one or more additional piping elements as integrated elements of the pipe where each of the one or more additional piping elements is one of a pipe fitting, a valve, and a support; and
a wall of the pipe comprises at least one of a three dimensional scaffold structure and a series of hollow openings along the length of the pipe.

46-49. (canceled)

50. The method according to claim 1, wherein
each micro-reactor of the plurality of micro-reactors triggers a transition from liquid to solid for the build material or a predetermined portion of the build material upon a time scale of nanoseconds over a distance of nanometers;
each micro-reactor of the plurality of micro-reactors generates a micro-void within the solidified build material; and
the part once manufactured comprises at least one region of a plurality of regions where each region of the plurality of regions is characterized by having at least one of pores with a predetermined range of dimensions, pores with a predetermined pore density, an unconnected pore structure, and a connected pore structure.

51-53. (canceled)

54. The method according to claim 50, wherein
a final diameter of the micro-voids is established by at least one of a pressure generated by the build material solidifying around the micro-voids and a time constant of a solidification of the build material relative to a rate of collapse of the micro-voids under pressure generated by the build material.

55. The method according to claim 1, further comprising
a boundary between the build chamber and the medium chamber, where the boundary is acoustically transparent and at least one of:
optically non-transparent;
at least one of electrically non-conductive or magnetically non-conductive;
formed from one or more biological materials;
formed from a series of layers where each layer of the series of layers is formed from a material having defined optical, biological, electrical or acoustical properties.
